(19) United States
(12) Patent Application Publication
(10) Pub. No.: US 2015/0313398 A1
(43) Pub. Date: Nov. 5, 2015

(54) THERMODYNAMIC ENERGY-SAVING HEALTH COOKWARE

(71) Applicant: Jong Peter Park, Pasadena, CA (US)

(72) Inventor: Jong Peter Park, Pasadena, CA (US)

(21) Appl. No.: 14/797,113

(22) Filed: Jul. 11, 2015

Related U.S. Application Data
(63) Continuation-in-part of application No. 13/875,553, filed on May 2, 2013.
(60) Provisional application No. 62/173,317, filed on Jun. 9, 2015.
(60) Provisional application No. 62/191,305, filed on Jul. 10, 2015.

(51) Int. Cl. A47J 27/00; A47J 36/06; A47J 41/00; A47J 36/02

(52) U.S. Cl. CPC A47J 27/002; A47J 36/02; A47J 36/06; A47J 41/0072

(57) ABSTRACT

Some embodiments provide a cooking apparatus having a dual wall structure, including inner and outer shells. The inner shell is disposed adjacent the outer shell and the edges of the shells are hermetically sealed to form a cavity between the shells. In some embodiments, the cavity is filled at least partially with a thermal conductive medium to form a thermodynamic layer that can absorb and retain heat for an extended period time. To improve high vacuum environment, the inner space of the multi-layered container of some embodiments includes a reactive material that absorbs and traps different gaseous mediums for an extended period of time.

### CLAIM OF BENEFIT TO PRIOR APPLICATIONS

This application claims the benefit of U.S. Provisional Patent Application 62/173,317, filed Jun. 9, 2015. This application also claims the benefit of U.S. Provisional Patent Application 62/191,305, filed Jul. 10, 2015. This application is also a continuation in part application of U.S. patent application Ser. No. 13/875,553, filed May 2, 2013, and published as U.S. Patent Application Publication 20140326733. U.S. Patent Applications 62/173,317 and 62/191,305; and U.S. Patent Application Publication 20140326733 are incorporated herein by reference.

### BACKGROUND

With today's busy lifestyle and the abundance of processed food, many people are generally eating a lot less nutrients and a lot more calorie dense food. This can potentially lead to health problems if they are not conscious of the food they are consuming. Also, with such busy lifestyles, time is so important for some people that they just don't have time to stand in the kitchen to prepare healthy meals.

Further, with conventional cooking methods, a person may find it difficult to prepare a nutritious meal. The person may have to cook different parts of the meal separately. The person may have to use multiple different types of cookware (e.g., pot, slow cooker, steamer, rice cooker, oven, etc.). In addition, the person might not have much experience cooking food. Undercooking food can potentially increase the risk of food borne illness; and overcooking food can potentially change its taste and/or texture, and can potentially even lead to additional nutrient losses.

### BRIEF SUMMARY

Embodiments described herein provide an eco-green, waterless, energy-saving, low pressure, thermodynamic, and easy-to-use cookware that promotes health. In some embodiments, the cookware comprises a container having a dual wall structure, including inner and outer shells. The inner shell is disposed adjacent the outer shell and the edges of the shells are hermetically sealed to form a cavity between the shells. In some embodiments, the cavity is filled at least partially with a thermal conductive medium to form a thermodynamic layer that can absorb and retain heat for an extended period time.

To improve high vacuum environment, the inner space of the multi-layered container of some embodiments includes a reactive medium. The reactive medium absorbs any gas molecules that are formed within the cavity when the container is heated. When a gaseous medium make contact with the reactive material, the gaseous medium is combined with the reactive material through a chemical reaction. In some embodiments, the reactive material is getter that can absorb heated air and retain it for several hours.

In some embodiments, the cookware comprises a lid that allows it to operate as a low pressure cooker. The low-pressure creating lid has a glass disk. The glass disk may be made of tempered glass. The glass disk is surrounded by a rim (e.g., silicone rim) and has an aperture in which a pressure valve is installed. The pressure valve regulates pressure by maintaining a low pressure cooking environment within the container. When the cookware is heated with a food item, pressure starts building up within the container due to the heated water content of the food item. The pressure causes the outer rim to be pushed outwards. This prevents steam from leaving though the sides of the lid. At the same time, the predetermined pressure level of the pressure release valve keeps the food item cooking under low pressure. However, when there is excess pressure, the pressure valve opens up to relieve the container of the excess pressure.

In some embodiments, the cooking apparatus has a lid that locks in or traps a moisture seal formed on a groove of the rim of the container. To substantially cover the container and facilitate in retaining moisture collected in the grooved-rim, the moisture seal locking lid of some embodiments has a flat side edge to fit in the container and sit over the grooved-rim. In some embodiments, the edge is pressed or folded vertically (e.g., upwardly, downwardly) to form the flat side edge. When the container is heated with a water-containing item and the lid is placed over the container, the water eventually vaporizes and hits the lid's inner surface area. Some of that water may flow (e.g., trickle down) into to the moisture groove. The groove may then fill up with water to create a moisture seal. At the same time, the vertical form of the lid's outer edge and the matching vertical form of the container's outer edge create a locking mechanism that locks in the moisture seal to makes it difficult for the moisture to leak out through the side where the lid sits on the container.

In some embodiments, the cookware has an outer shell that is coated with an exothermic enamel glaze. The exothermic glaze can serve multiple different purposes. As it adds another layer to the multi-layered container, the glaze further insulates the container. The glaze absorbs thermal energy from the outer shell, and retains it until it is lost. This can further facilitate in saving energy when using the cooking apparatus. The glaze also allows fast heat transfer into the container. For some embodiments of the cookware that is to be used with a microwave oven, the exothermic enamel glaze absorbs electromagnetic waves from the microwave oven's magnetron and converts them into thermal energy through oscillation.

The exothermic coat of some embodiments is an exothermic glaze having a mixed metal powder compound (e.g., Fe2O3) with ferrosilicon (Fe—Si) powder, aluminum silicate powder, and ethylene glycol. Instead of the exothermic glaze, the cookware of some embodiments is coated with a ceramic coat. The ceramic coat of some embodiments is a mixture of ceramic powder and exothermic particles. In some embodiments, the exothermic particles include iron oxide (Fe2O3) powder with Manganese (Mn) and Zinc (Zn) powder, or copper-nickel-zinc (Cu—Ni—Zn) powder for electro-microwave absorption.

In some embodiments, the cookware has a lid that is at least partially coated with a thermo-chromic paint. The paint changes between different colors when the container is heated and cooled. In some embodiments, the thermo-chromic paint's pigment changes between at least three different colors representing different thermal ranges. For instance, when the vessel is heated, the thermo-chromic paint may change in color from a first color (representing no heat) to a second color (representing low heat), then from the second color to a third color (representing medium heat), and finally from the third color to a fourth color (representing high heat).

Some embodiments provide a flip and lock handle for a container. The flip and lock handle is also referred to herein as a click and lock handle. The container can be multi-walled container or a single walled container. The click and lock handle of some embodiments includes a handle having (i) an opening to rotate along an axis on the side of the vessel, and (ii) a set of one or more guiding members. The click and lock handle also has a clicking or clicking member to click the handle out of a particular position. The click and lock handle also has a handle connector that rotatably couples the handle to the vessel. The connector has a set of one or more grooves that fits the set of guiding member and guides the guiding members along the axis. In some embodiments, the set of grooves guides the handle from one of two different positions: a downright position and a side lateral position. To make the vessel safe to handle, the set of grooves locks the handle by preventing the handle from being adjusted to a different position (e.g., to a position beyond the side lateral position).

The preceding Summary is intended to serve as a brief introduction to some embodiments as described herein. It is not meant to be an introduction or overview of all subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawings, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purposes of explanation, several embodiments of the invention are set forth in the following figures.

FIG. 1 illustrates a cooking apparatus according to some embodiments of the invention.

FIG. 2 shows a thermodynamic layer of a multi-layered container according to some embodiments.

FIG. 3 illustrates a cross sectional view of a multi-layered container that is coated with a heat-retention glaze.

FIG. 4 illustrates a cross sectional view of a cooking apparatus according to some embodiments of the invention.

FIG. 5 illustrates a thermo-insulated lid according to some embodiments.

FIG. 6 illustrates a sealing ring that assists in sealing the inner chamber of a multi-layered cooking apparatus according to some embodiments of the invention.

FIG. 7 illustrates an example welding process to weld the edges of the inner and outer shells together.

FIG. 8 shows an interlocking joint according to some embodiments.

FIG. 9 illustrates a top view of an inner lid according to some embodiments.

FIG. 10 illustrates a silicone ring that is attached to the inner lid.

FIG. 11 illustrates a moisture seal locking cover acceding to some embodiments of the invention.

FIG. 12 illustrates a low-pressure creating cover according to some embodiments of the invention.

FIG. 13 shows a top perspective view of the low-pressure creating lid of FIG. 12.

FIG. 14 shows a bottom perspective view of the low-pressure creating lid of FIG. 12.

FIG. 15 shows an exploded view of a pressure release valve according to some embodiments of the invention.

FIG. 16 illustrates a multi-layered container of some embodiments that has an exothermic plate.

FIG. 17 shows a heat transfer plate with a flow path formed thereon.

FIG. 18 illustrates a stacked structure of bottom plates according to some embodiments of the invention.

FIG. 19 illustrates another stacked structure of bottom plates according to some embodiments of the invention.

FIG. 20 illustrates a cross-sectional view of a multi-shelled vessel of some embodiments in which at least one of the shells is used to form a flow path.

FIG. 21 shows a cross-section view of a pressure release valve of some embodiments.

FIG. 22 shows a pressure control valve according to some embodiments of the invention.

FIG. 23 shows a cross sectional view of a lid handle according to some embodiments of the invention.

FIG. 24 shows a bottom view of a lid handle a according to some embodiments.

FIG. 25 shows a lid handle with a pressure release switch.

FIG. 26 shows the top view of the lid handle according to some embodiments.

FIG. 27 illustrates an example of a click and lock handle according to some embodiments of the invention.

FIG. 28 illustrates a spring of the click and lock handle of some embodiments.

FIG. 29 illustrates a handle of the click and lock handle according to some embodiments of the invention.

FIG. 30 illustrates a support frame of the click and lock handle according to some embodiments of the invention.

FIG. 31 illustrates a handle connector of the click and lock handle according to some embodiments of the invention.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide an eco-green, waterless, energy-saving, low pressure, thermodynamic, and easy-to-use cookware that promotes health. The cookware or cooking apparatus includes a multi-layered container having a thermodynamic layer that can absorb and retain heat for an extended period of time. In some embodiments, the cookware includes a lid that, when placed on the container, changes between different colors with the change in the container's temperature (e.g., within the thermodynamic layer).

In some embodiments, the cookware is an “easy-to-use” cookware because it allows a person to prepare a meal by simply (i) adding all the different ingredients of a recipe (e.g., at once) to the multi-layered container, (ii) covering the container, and (iii) turning the heat source on (e.g., turn on a stove top to medium/high heat). Once the container comes to a desired thermal range as suggest by the recipe, the person can then (iv) remove the cookware from the heat source and turn off the heat source, and walk away and allow the cookware to slow cook the ingredients. Accordingly, the cookware can also be considered a “walk-away” cookware, or even a low pressure or slow cooker.

To make it even easier-to-use, the cookware of some embodiments provides different colors for different thermal ranges. So, a person can simply look at the lid's color or optionally at a multi-colored thermal gauge of some other embodiments that is on the lid or container, and see that it's time to remove the container from the heat source (e.g., as the cookware has reached a desired thermal range). Different recipes can have different thermal ranges. The recipes themselves may be created by the entity that produces the cookware and/or the people that use it.

As the cookware absorbs thermal energy from a heat source and retains it for an extended period of time (e.g., 3-6 hours or even longer depending on the thermal conductive medium, the reactive medium, and/or one or more various other components described herein), it can also be considered an energy-saving cookware.

As will be elaborated below, the cookware of some embodiments has various features or components to make it a waterless cookware. By waterless, the cookware traps moisture from food and allows the food to cook or baste in its own juices. This assists in retaining nutrients of the food without overcooking or undercooking it, which ultimately makes the cookware a health-promoting cookware or, simply, a health cookware.

In some embodiments, the cookware is an “all-in-one” multi-purpose cookware that can be used to replace one or more different types of cookware. As a first example, the cookware can be used replace a steamer (e.g., to steam vegetables). Different from a steamer, the cookware can operate without adding water. A person can simply add the moisture-rich ingredients (e.g., vegetables) and let those ingredients slowly baste in their own moisture. The multi-layered structure of the apparatus prevents hotspots, which can potentially burn the ingredients, from forming. The cookware can also replace a rice cooker. Once rice is prepared with the apparatus, the rice is kept warm for an extended period of time without the apparatus being placed back on any heat source. The cookware can also be used for baking purposes (e.g., to bake a cake). Thus, in some cases, the apparatus may be used in place of an oven.

The cookware of some embodiments can operate with different appliances. In some embodiments, the cookware operates with an electric stove, a gas stove, and an induction cooker. In some embodiments with exothermic performance, the cookware can also heat its content with a microwave oven.

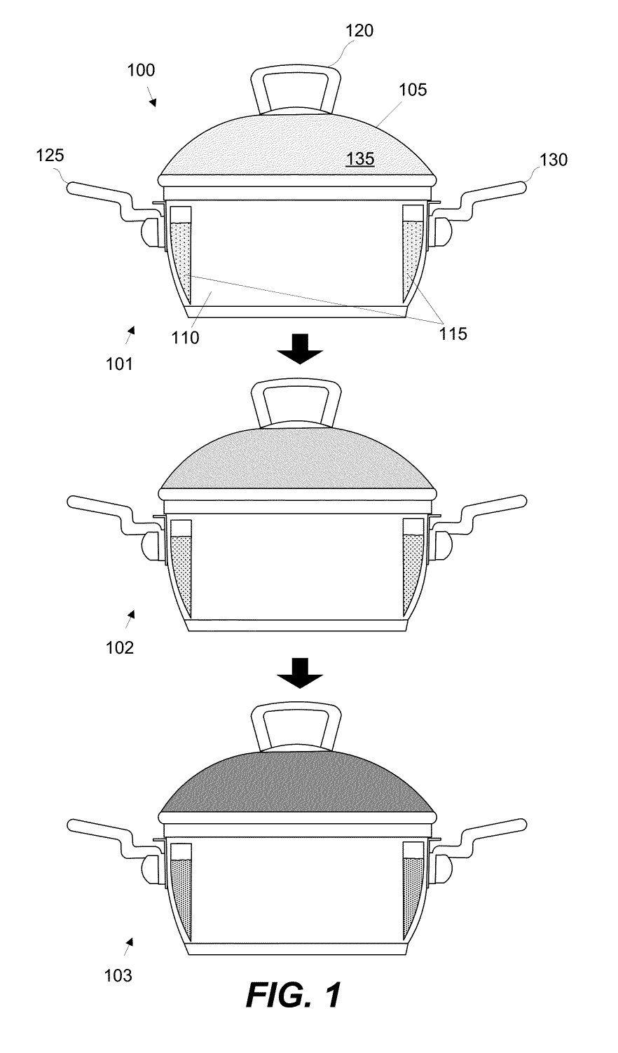

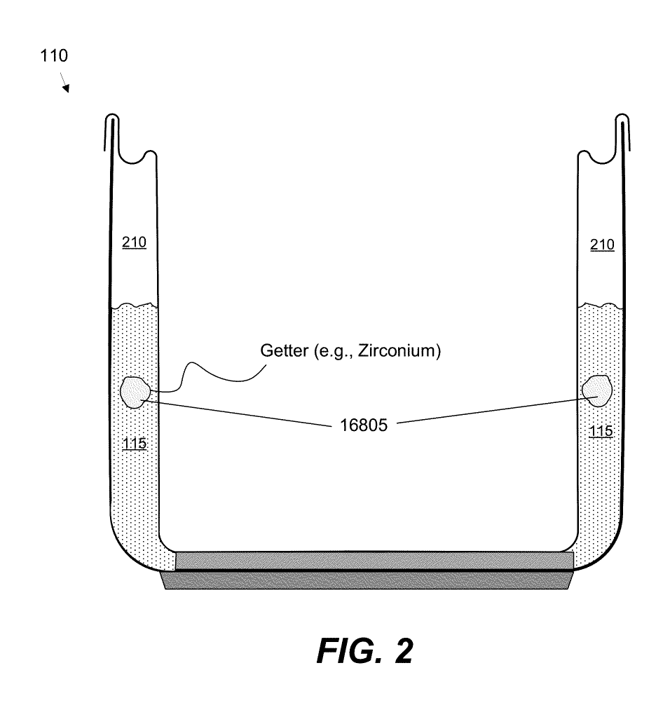

FIG. 1 illustrates a cookware 100 according to some embodiments of the invention. Specifically, the figure shows in three operational stages 101-103 how the color of the cookware's lid 105 changes as its multi-layered container 110 is heated on a heat source (not shown). These stages 101-103 will be described in detail below after an introduction of some of the components shown in the figure. Also, this figure will be described by reference to FIG. 2, which shows a thermodynamic layer of a multi-layered container according to some embodiments.

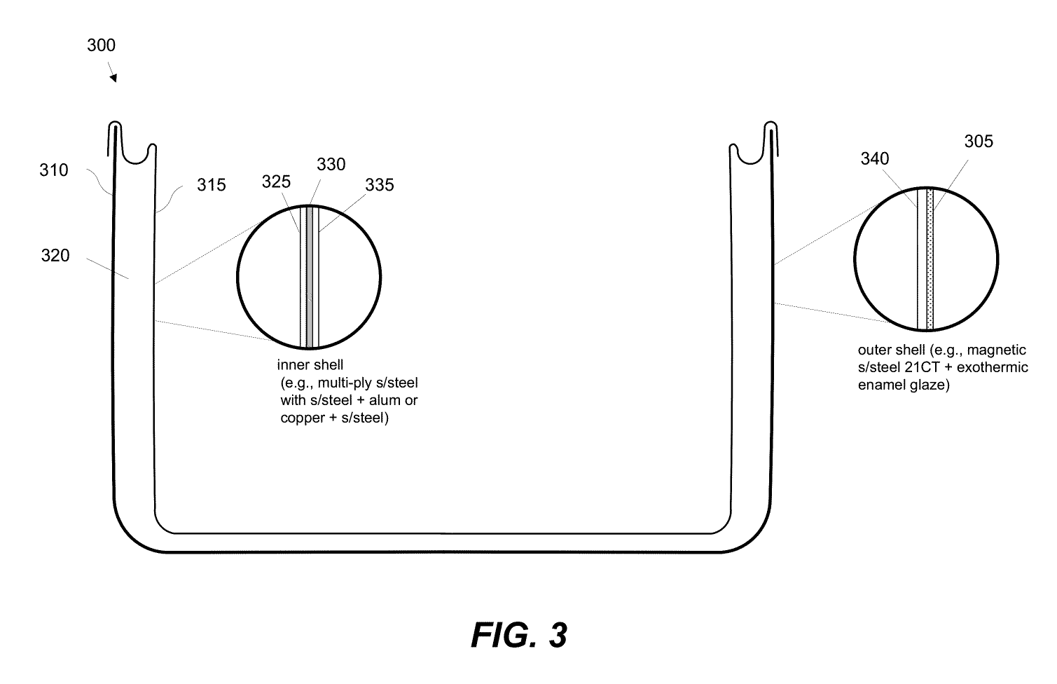

The multi-layered container 110 includes a thermodynamic layer 115 that can absorb and retain heat for an extended duration of time. In some embodiments, the multi-layered container 110 has a dual wall structure, including inner and outer shells. Each of the inner and outer shells can be made up a single layer of metal, such as stainless steel. Alternatively, each shell can be made of a multi-layered composite material. Several examples of such multi-layered composite materials will be described below by reference to FIG. 3.

To form the thermodynamic layer 115, the inner shell is disposed adjacent the outer shell. The edges of the two shells are then hermetically sealed to form a cavity (i.e., inner space, pocket of space, wall space) between them. The cavity is at least partially filled with a thermal conductive medium (i.e., heat retention medium, heat transfer medium).

Different embodiments can use different thermal conductive mediums 115. In some embodiments, the cookware uses a gaseous medium, such as ambient air. In some embodiments, the inner space is at least partially filled with a compound, such as silicone oil. In some embodiments, the inner space is at least partially filled with a fibrous medium, such as carbon fiber. The inner space may have a piece of fiberglass woven fabric for insulation. The fiberglass woven fabric may have a honeycomb form. For instance, the fabric can have a number of cells that are similar in appearance to those of a bee's honeycomb. The honeycomb fiberglass fabric may be used because it is lightweight, fire resistant, flexible, and has good impact resistance.

In some embodiments, the fibrous medium includes ceramic wool fiber for insulation. In some embodiments, the inner space has a piece of material made with ceramic fiber. In some embodiments, the material is a ceramic fiber blanket or mat. The blanket is a lightweight, thermally efficient ceramic fiber insulating material that has dimensional stability at high temperature. In some embodiments, the blanket is made from high-purity alumina, zirconia, and silica spun ceramic fibers. In some embodiments, the blanket has a temperature grade around or above 760° Celsius (C).

In some embodiments, the fibrous medium includes glass cloth.

In some embodiments, the inner space includes a quilted panel. The panel may be made using glass cloth. The panel may be sewn into a pillow-like shape and filled with silica powder mixture. The panel may be sewn first closed and then compressed. The sewing technique allows the panel to be flexible. For instance, the quilted panel can be wrapped around the outer side wall of the inner shell of the double-walled vessel. The panel can also withstand abuse that the cookware is subject. That is, the panel is resistant to various vibration and motion of the vessel. Depending on the size of the inner chamber, the thicknesses of the panel may change.

In some embodiments, inner space contains a thin sheet of micro-porous insulation material. The thin sheet may be made with a micro-porous board material. As the board can be delicate, it might be coated in some manner to reinforce the board material. The thin sheet may be made primarily with pyrogenic silica. The thin sheet may be reinforced in some manner (e.g., with e-glass filament, oxide opacifier, etc.).

In some embodiments, the inner space includes a piece of foam to keep food items hot for several hours. In some embodiments, the foam is made of polyurethane. In some embodiments, the inner space is at least partially filled with a chemical gel. In some embodiments, the chemical gel includes ammonium nitrate, calcium chloride, sodium chloride, sodium acetate, and ammonium chloride. One of the benefits of using such a gel is for its endothermic performance or its ability to absorb heat. That is, the gel can be used to keep food cold for an extended period of time.

In some embodiments, the inner space is at least partially filled with a set of one or more thermal conductive pads. The inner space can be filled at least partially with a thermal conductive gel. For faster heat absorption and transfer, the inner space may include a silicone-based material that is mixed with an aluminum oxide compound. In some embodiments, the inner space is at least partially filled with a silicone rubber having ferrite particles (e.g., manganese zinc (MnZn) ferrite particles).

In some embodiments, the inner space of the multi-layered container is at least partially filled with a reactive medium or material that absorbs one or more different gaseous mediums, such as the ambient air mentioned above, and hold the gaseous mediums for an extended period of time. This is to improve and maintain a vacuum inside the sealed inner space. The reactive material of some embodiments can absorb different types of gas molecules, such as H₂O, O₂, N₂, CO, CO₂, etc.

When a gaseous medium makes contact with the reactive material, the gaseous medium is combined with the reactive material through a chemical reaction. The reactive material essentially absorbs or eliminates even small amounts of gas molecules from the inner space. In some embodiments, the reactive material is getter that can absorb heated air and retain it for several hours. In some embodiments, a deposit of getter material is placed in the inner space of the multi-layered container. In some embodiments, the getter comprises zirconium (Zr). In some embodiments, the getter is primarily zirconium-based in amount or volume but can include one or more other elements, e.g., aluminum (Al), cobalt (Co), iron (Fe), etc.

In some embodiments, the reactive material is injected or placed in the inner chamber of the multi-layer container with one or more of the thermal conductive material listed above. FIG. 2 shows a thermodynamic layer 210 of a multi-layered container 110 according to some embodiments. As shown, the inner space or thermodynamic layer 210 is at least partially filled with a thermal conductive medium 115 (e.g., silicone oil, ambient air, silicone oil and ambient air, thermal conductive gel, etc.). The thermodynamic layer 210 also has getter 205.

When the multi-layered container 110 is heated, the air within the thermodynamic layer 115 is heated, and its air molecules are absorbed by getter 205. The getter 205 can retain the heated air for several hours, similar to a thermal flask. For instance, when getter is placed in the thermodynamic layer with ambient air, the multi-layered container may remain heated for about 5 to 6 hours. In some embodiments, the inner space has getter and ambient air. In some embodiments, the inner space has getter and silicone oil.

Referring to FIG. 1, the multi-layered container 110 has a pair of handles 125 and 130. The handles are attached on opposite side of the outer shell. In some embodiments, the handles are made of metal, such as stainless steel. In some embodiments, each handle is hollowed out in order to make them safe to touch when the container is heated. In some embodiments, each handle is connected to a part (e.g. a hollow part, a triangular-shaped part) that prevents heat conduction between the handles and the container. Although FIG. 1 shows a pair of handles 125 and 130, the container 110 can include only one handle or even more handles.

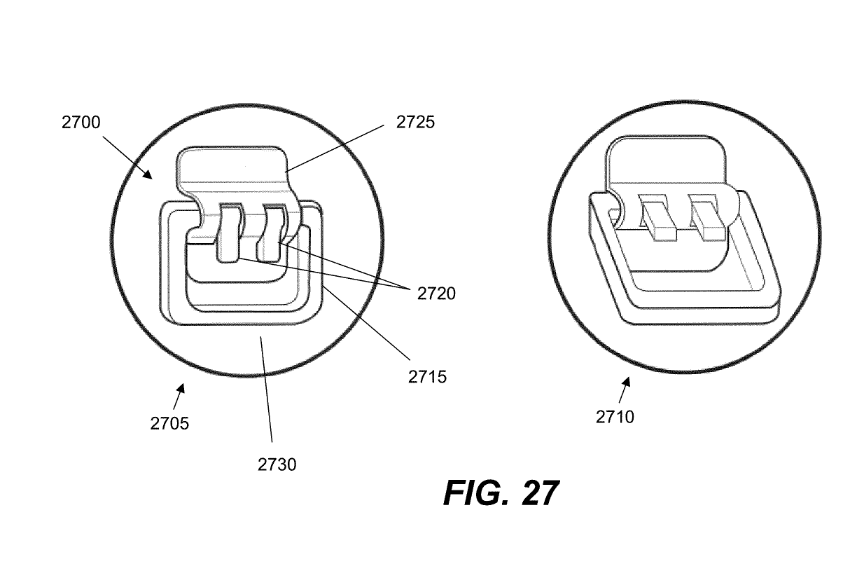

In some embodiments, each of the handles 125 or 130 can be adjusted (e.g., clicked and locked) into one or more different positions. In some embodiments, each handle 125 or 130 can be clicked and locked into an upright or downright position in order to save space when storing the container 110. In some embodiments, each handle 125 or 130 can be clicked and locked into a side lateral position for handling the container, and clicked and locked out of the side lateral position to a downright position for storing the container. Examples of such an adjustable handle will be described below by reference to FIG. 27-31.

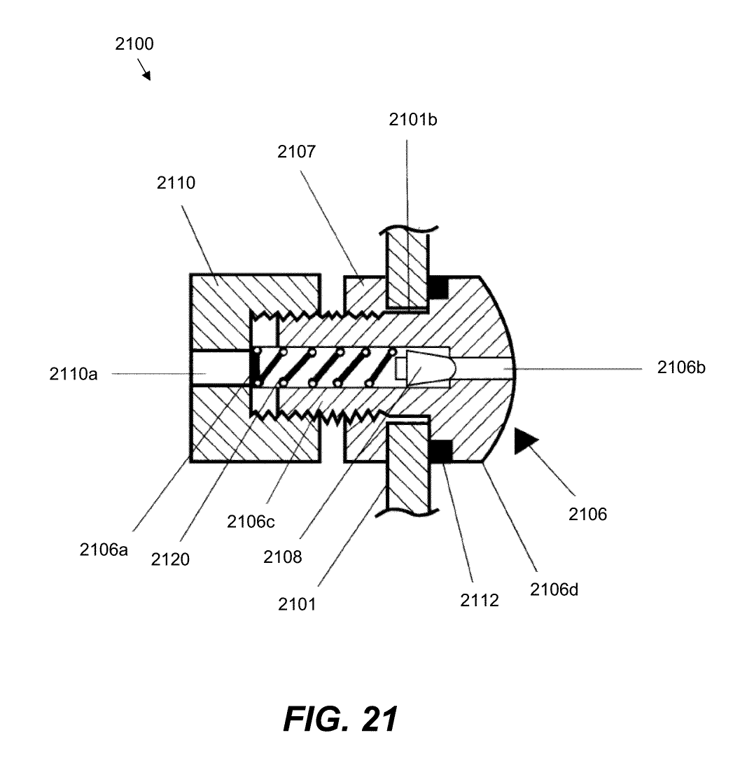

In some embodiments, the multi-layered container 110 includes a pressure releasing member (not shown) to prevent its multiple layers from separating with the expansion of the thermal conductive medium due to heat. Several examples of different pressure-releasing members will be described below by reference to FIGS. 21 and 22.

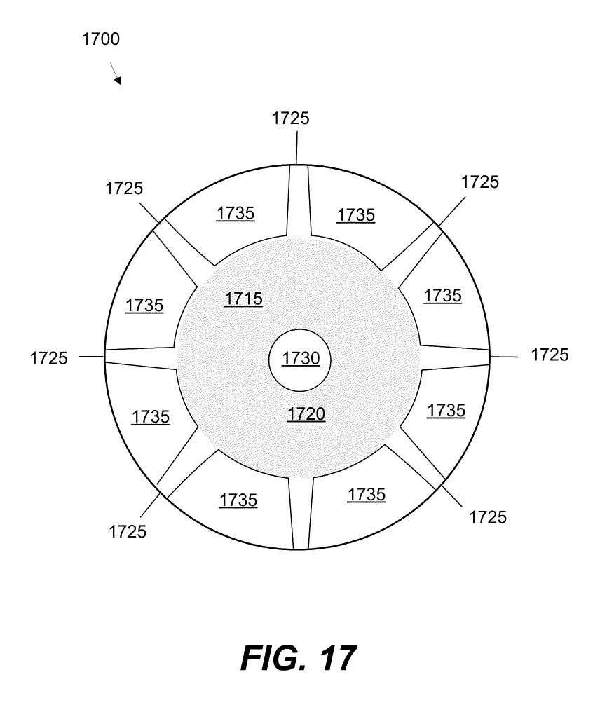

To provide speedy transmission of heat to the food contained therein, the cooking apparatus 100 of some embodiments includes one or more heat conductions plates. For instance, the multi-layered container 110 of some embodiments includes a first heat conduction plate that is securely affixed to the outer bottom surface of the outer shell. In some embodiments, the multi-layered container 110 has a second heat conduction plate that is disposed between the inner and outer shells. Several examples of such second heat conduction plates will be described in detail below by reference to FIGS. 17-20.

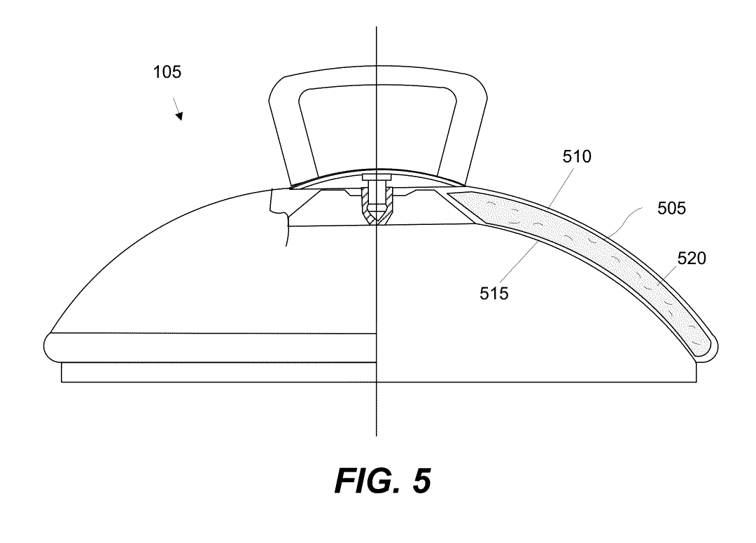

Referring to FIG. 1, the cookware 100 has a thermal insulating cover 105 that is at least partially coated with a thermo-chromic paint 135. The paint 135 changes between different colors when the vessel (i.e., container) is heated and cooled. In some embodiments, the cover 105 is produced by coating a metallic plate (e.g., a stainless steel plate) with the thermo-chromic paint 135. In some embodiments, the metallic plate is a stainless steel plate being about 0.5 to 0.7 mm thick. In some embodiments, the metallic plate is about 0.6 mm thick, and has a dome-like shape. In some embodiments, the cover 105 is a thermal insulating cover in that it is multi-layered, including a heat insulating layer. Several example of the thermal insulating cover will be described below by reference to FIG. 5.

In some embodiments, the thermo-chromic paint's pigment changes between at least three different colors representing different thermal ranges. For instance, a first color can represent low heat, a second color can represent medium heat, and a third color can represent high heat. In some embodiments, when the vessel is heated, the thermo-chromic paint 135 changes in color from a first color (representing no heat) to a second color (representing low heat), then from the second color to a third color (representing medium heat), and finally from the third color to a fourth color (representing high heat).

In some embodiment, the thermo-chromic paint's pigment can change in color to draw out some shape or character. For instance, when the multi-layered vessel 110 is heated, a first shape may gradually appear on the cover 105 to indicate that the vessel is set to a first thermal range, then a second shape may gradually appear on the cover to indicate a second higher thermal range, and finally a third shape may gradually appear on the cover to indicate a third highest thermal range.

In some embodiments, the thermo-chromic paint 135 can be used on other parts of the cooking apparatus 100. However, the paint may be compromised (e.g., start melting and eventually burning) if it is too close to the heat source because it can only withstand a certain amount of heat.

Referring to FIG. 1, the thermal insulating cover 105 has a handle 120. Similar to the side handles 125 and 130, the cover handle 120 can be made of metal, such as stainless steel. In some embodiments, the handle 120 is hollowed out in order to make it safe to touch when the container is heated. In some embodiments, the handle 120 is connected to a part (e.g. a hollow part) that prevents heat conduction between the handle and the cover's metallic plate.

Having described several components of the cooking apparatus 100 of FIG. 1, the operations of the cooking apparatus will now be described by reference to the three stages 101-103 that are illustrated in the figure. In the first stage 101, the cooking apparatus 100 is in a first state, which might be a no heat state. The lid 135 is shown with a first color. In the second stage 102, the cooking apparatus is in a second state, which might be a low heat state. Thus, the lid 105 is shown with a second different color. In the third stage 103, the cooking apparatus 100 is in a third state, which might be a medium heat state. As such, the lid 105 is shown with a third different color.

In some embodiments, the cooking apparatus has a multi-layered container that is coated with a heat-retention glaze. FIG. 3 illustrates a cross sectional view of a multi-layered container 300 that is coated with such a heat-retention glaze 305. The container 300 of the cooking apparatus according to some embodiments of the present invention includes an outer shell 310 and an inner shell 315 disposed adjacent the outer shell.

Edges of the outer and inner shells 310 and 315 are, in some embodiments, welded together, then rolled, and finally compressed to form a rolled joint. In some embodiments, an elastic ring is placed firmly within the rolled joint to form a complete interlocking joint. In some embodiments, the elastic ring is a silicone ring. In some embodiments, the edges of the outer and inner shells 310 and 315 are welded together by a seamless welding method. Alternatively, the edges can be welded by an argon arc method. Further, the edges can be welded together first by a seamless welding and then finished by an argon arc welding at the end. The rolled joint seals the cavity 320 that is formed between the outer and inner shells 310 and 315.

In some embodiments, the distance between the outer and inner shells 310 and 315 is approximately 15 to 25 mm, and, in some embodiments, is about 20 mm. In some embodiments, the outer and inner shells 310 and 315 are made of such materials as (e.g., AISI304) stainless steel that has a thickness of about 0.6 mm. Alternatively, instead of using a single-layered stainless steel, a multiple-layered composite material may be used. For some embodiments of the outer or inner shell 310 or 315, three or more layered stainless steel; or a combination of (i) stainless steel ply, and (ii) copper or aluminum ply, and (iii) stainless steel ply is used to fabricate that shell.

In some embodiments, the outer shell 310 is fabricated using a piece of metal that has magnetic properties. The magnetic properties of the metal allow the vessel 300 to heat food items on an induction cooker.

As mentioned above, the container 300 has outer and inner shells 310 and 315. Referring to the exploded view of the inner shell 315 of FIG. 3, the inner shell is a multi-ply shell in that it has an outer stainless steel layer 325, a middle copper or aluminum layer 330, and an inner stainless steel layer 335.

Referring to the exploded view of the outer shell 310 of FIG. 3, the outer shell uses a different set one or more of plies and a set of one or more different coatings. Different from the inner shell 315, the outer shell 310 of some embodiments is a single steel ply 340 that is coated with a heat-retention glaze 305. In some embodiments, the outer shell is made with magnetic stainless steel (e.g., 21CT). However, similar to the inner shell 315, the outer shell 310 may be produced using multiple plies.

As shown in FIG. 3, the outer surface of the outer shell 310 is at least partially covered with the heat-retention glaze 305. The heat-retention glaze 305 can serve multiple different purposes. As it adds another layer to the multi-layered container 305, the glaze further insulates the container 300. The glaze 305 absorbs thermal energy from the outer shell 310 and retains it until it is lost. This can further facilitate in saving energy when using the cooking apparatus. The heat-retention glaze also allows fast heat transfer into the container.

For some embodiments of the container 300 that is to be used with a microwave oven, the heat-retention glaze 305 absorbs electromagnetic waves from the microwave oven's magnetron and converts them into thermal energy through oscillation. The thermal energy is then transferred to the outer shell 310, which causes the thermal conductive medium to be heated (e.g., from all sides of the vessel 300, including the side wall and the bottom side).

In some embodiments, the heat-retention glaze 305 is an exothermic enamel glaze or exothermic ceramic glaze 305. The exothermic enamel glaze of some embodiments has manganese-zinc ferrite and ferrosilicon. In some embodiments, the exothermic ceramic glaze 305 is a mixed metal alloy powder compound comprising ferrite, silicon (Si), and aluminum (Al). In some embodiments, the glaze 305 is coated on at least a portion of the outer surface vessel and dried. In order to produce the outer enamel, the dried glaze may be subject to a glassification process. In some embodiments, the outer shell is coated with the glaze and baked at around 850° C.

The exothermic coat of some embodiments is an exothermic glaze having a mixed metal powder compound (e.g., Fe2O3) with ferrosilicon (Fe—Si) powder, aluminum silicate powder, and ethylene glycol. Instead of the exothermic glaze, the cookware of some embodiments is coated with a ceramic coat. The ceramic coat of some embodiments is a mixture of ceramic powder and exothermic particles. In some embodiments, the exothermic particles include iron oxide (Fe2O3) powder with Manganese (Mn) and Zinc (Zn) powder, or copper-nickel-zinc (Cu—Ni—Zn) powder for electro-microwave absorption.

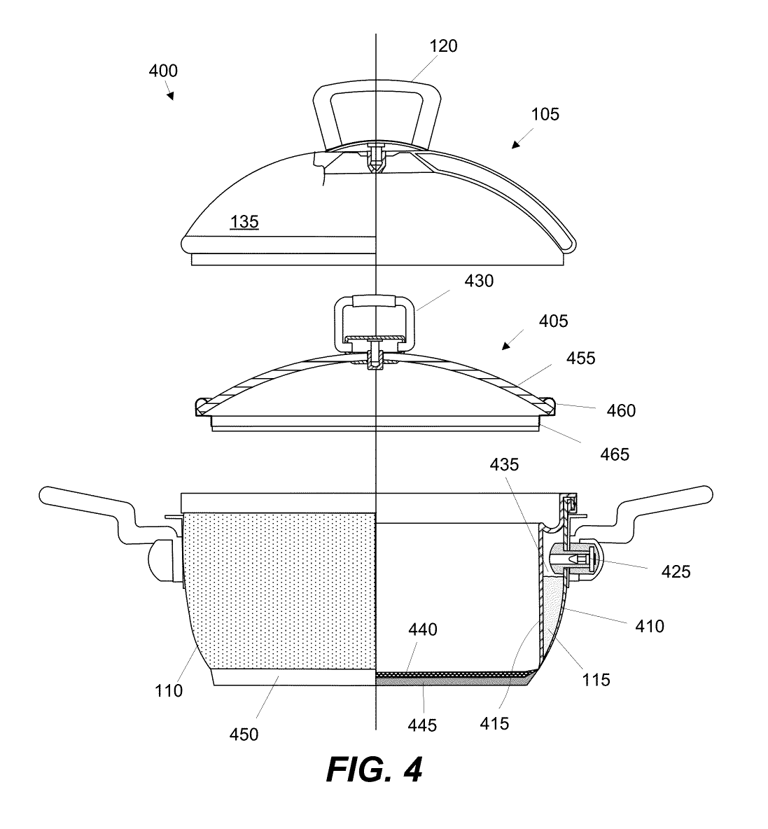

FIG. 4 illustrates a cross sectional view of the cooking apparatus 400 according to some embodiments of the invention. The apparatus 400 has a thermo-insulated lid 105, an inner lid 405, and a container 110. The container 110 has outer and inner shells 410 and 415. There is a pocket of space 435 between the two shells 410 and 415. The pocket 435 includes a thermal conductive medium 115.

As shown in FIG. 4, the cooking apparatus 400 of some embodiments include a pressure release value 425. The valve 425 may be installed on the side of the outer shell 410 to release any excess pressure built up in the cavity 435 when the container 110 is heated. Pressure can be built up because the ambient air with moisture and/or the heat-retention medium can expand when the vessel is heated. Also, during submersion in water, such as when being cleaned, or when placed in areas of high humidity, water and/or moisture may flow or collect within the inner chamber 435 of the double-layered vessel 110. After heating the double-layered vessel, the moisture within the inner chamber 435 is transformed into a vaporized state, i.e. steam. Consequently, the volume of the liquid or moisture, now in a vapor or gaseous state, is increased. Thus, the pressure release valve 425 provides the means to decrease the volume by discharging the steam, thereby relieving stresses on the outer and inner shells 410 and 415 of the vessel 400. Several different examples of different pressure release valves will be described below by reference to FIGS. 21 and 22.

The cooking apparatus 400 of some embodiments includes one or more heat conductions plates. Referring to FIG. 4, there is provided a first heat conduction or transfer plate 440 placed between the outer and inner shells 410 and 415. The first heat conduction plate 440 can be made of an aluminum disk, copper, or other suitable materials known to one of ordinary skill in the art. The first heat conduction plate can also be, in some embodiments, flushly affixed to the inner bottom surface of the outer shell 410. The first heat conduction plate may be about 1.5 to 2.5 mm thick, and is, in some embodiments, about 2 mm thick. To provide the speedy transmission of heat to the food contained in the cooking apparatus 400, the first heat conduction plate 440 may abut against the outer bottom surface of the inner shell 415. Due to the presence of the first conduction plate 440, there may be no space or cavity between the bottom of the inner shell 415 and that of the outer shell 410. However, as will be described below by reference to FIG. 17, in some embodiments, the first conduction plate 440 include a fluid or flow path for the thermal conductive medium 115.

In some embodiments, a second heat conduction plate 445 is disposed below the outer bottom surface of the outer shell 410 (e.g., below the first heat conduction plate 440). Similar to the first heat conduction plate 440, the second heat conduction plate 445 can be made of an aluminum disk or other suitable materials known to one of ordinary skill in the art. The second heat conduction plate can be about 2 to 4 mm thick, and is, in some embodiments, about 3 mm thick. The second heat conduction plate 445 is securely affixed to the bottom of the outer shell 410 by brazing or other suitable method known to one of ordinary skill in the art.

In some embodiments, the second heat conduction plate 445 is covered with a support cover 450. The support cover 450 is attached to an outer bottom surface of the outer shell 410 fully surrounding and in contact with the second heat conduction plate 445. The support cover 450 is, in some embodiments, made of the same material as that of the container 110 of the cooking apparatus 400. In some embodiments, the support cover 450 is made of AISI304 stainless steel that has a thickness of about 0.5 mm. In some embodiments, within the container 110, the first heat conduction plate 440, the bottom wall of the outer shell 410, the second heat conduction plate 445, and the support cover 450 are in thermal communication with each other.

The cooking apparatus 400 of some embodiments includes an inner lid 405. In some embodiments, the inner cover 405 is constructed with a dome-shaped disk 455 of which edge is surrounded by a safety ring 460 made of stainless steel or other suitable materials. The safety ring 460 is attached to the edges of the disk 455, thereby preventing damages to the disk. However, the inner lid 405 may be used without the ring 460. In some embodiments, the disk 455 is made to form a slight convexed surface with respect to the container 110 of the cookware 400.

The disk 455 of the inner lid 405 is, in some embodiments, made of tempered glass (e.g., of approximately 4 mm thick.) Alternatively, the disk 455 may be made of stainless steel, aluminum, aluminum alloy, or other suitable materials known to one of ordinary skill in the art.

As shown in FIG. 4, a handle 430 is attached to the center of the dome-shaped disk 455 by, for example, piercing the central portion of the disk. Alternatively, the handle 430 may be affixed to the disk 455 by using adhesives or other fasteners. In some embodiments, the inner lid 405 has a sealing member 465. The sealing member 465 may be securely affixed around the bottom of the ring or disk 460 or 455. A portion of the member may sit on a rim provided by the inner shell 415. In some embodiments, the sealing member 465 has a portion that is inserted into the body. When the vessel 110 is heated and moisture evaporates, the inserted portion expands to seal the vessel and trap moisture. In some embodiment, the member 465 substantially seals the receptacle to prevent heat and moisture dissipation. In some such embodiments, the inner lid 405 includes at least one discharge port with a pressure release valve.

As mentioned above, the cooking apparatus 400 of some embodiments includes an outer thermal insulating cover 105. The thermal insulating cover may be coated a thermo-chromic paint 135 that changes between different colors when the vessel is heated and cooled. In some embodiments, the cover 105 is a thermo-insulated lid in that it is multi-layered. FIG. 5 illustrates a thermo-insulated lid 105 according to some embodiments. The lid 105 has outer and inner walls 510 and 515, and a pocket of space 505 formed between them. In some embodiments, the space 505 between the inner and outer walls is at least partially filled with a thermal conductive medium 520.

Different embodiments can use different thermal conductive mediums. In some embodiments, the cookware uses a gaseous medium, such as ambient air. The inner space can be filled at least partially with a thermal conductive gel. In some embodiments, the inner space is at least partially filled with a compound, such as silicone oil. In some embodiments, the inner space is at least partially filled with a fibrous medium, such as carbon fiber. In some embodiments, the inner space is at least partially filled with a set of one or more thermal conductive pads. For faster heat absorption and transfer, the inner space may include a silicone-based material that is mixed with an aluminum oxide compound. In some embodiments, the inner space is filled at least partially with a silicone rubber having ferrite particles (e.g., manganese zinc (MnZn) ferrite particles).

In some embodiments, the inner space is at least partially filled with a fibrous medium, such as carbon fiber. The inner space may have a piece of fiberglass woven fabric for insulation. The fiberglass woven fabric may have a honeycomb form. For instance, the fabric can have a number of cells that are similar in appearance to those of a bee's honeycomb. The honeycomb fiberglass fabric may be used because it is lightweight, fire resistant, flexible, and has good impact resistance.

In some embodiments, the fibrous medium includes ceramic wool fiber for insulation. In some embodiments, the inner space has a piece of material made with ceramic fiber. In some embodiments, the material is a ceramic fiber blanket or mat. The blanket is a lightweight, thermally efficient ceramic fiber insulating material that has dimensional stability at high temperature. In some embodiments, the blanket is made from high-purity alumina, zirconia, and silica spun ceramic fibers. In some embodiments, the blanket has a temperature grade around or above 760° Celsius (C).

In some embodiments, the fibrous medium includes glass cloth.

In some embodiments, the lid's inner space includes a quilted panel. The panel may be made using glass cloth. The panel may be sewn into a pillow-like shape and filled with silica powder mixture. The panel may be sewn first closed and then compressed. The sewing technique allows the panel to be flexible. For instance, the quilted panel can be wrapped around the outer side wall of the inner shell of the double-walled vessel. The panel can also withstand abuse that the lid is subject. That is, the panel is resistant to various vibration and motion of the vessel. Depending on the size of the inner chamber, the thicknesses of the panel may change.

In some embodiments, inner space contains a thin sheet of micro-porous insulation material. The thin sheet may be made with a micro-porous board material. As the board can be delicate, it might be coated in some manner to reinforce the board material. The thin sheet may be made primarily with pyrogenic silica. The thin sheet may be reinforced in some manner (e.g., with e-glass filament, oxide opacifier, etc.).

In some embodiments, the inner space includes a piece of foam. In some embodiments, the foam is made of polyurethane. In some embodiments, the inner space is at least partially filled with a chemical gel. In some embodiments, the chemical gel includes ammonium nitrate, calcium chloride, sodium chloride, sodium acetate, and ammonium chloride. One of the benefits of using such a gel is for its endothermic performance or its ability to absorb heat. That is, the gel can be used to keep food cold for an extended period of time.

In some embodiments, the inner space is at least partially filled with a set of one or more thermal conductive pads. The inner space can be filled at least partially with a thermal conductive gel. For faster heat absorption and transfer, the inner space may include a silicone-based material that is mixed with an aluminum oxide compound. In some embodiments, the inner space is at least partially filled with a silicone rubber having ferrite particles (e.g., manganese zinc (MnZn) ferrite particles).

To improve high vacuum environment, the pocket of space of the thermal insulating cover of some embodiments includes a reactive medium. The reactive material absorbs gas molecules that are formed within the space when the container is heated. When a gaseous medium make contact with the reactive material, the gaseous medium is combined with the reactive material through a chemical reaction. In some embodiments, the reactive material is getter that can absorb heated air and retain it for several hours.

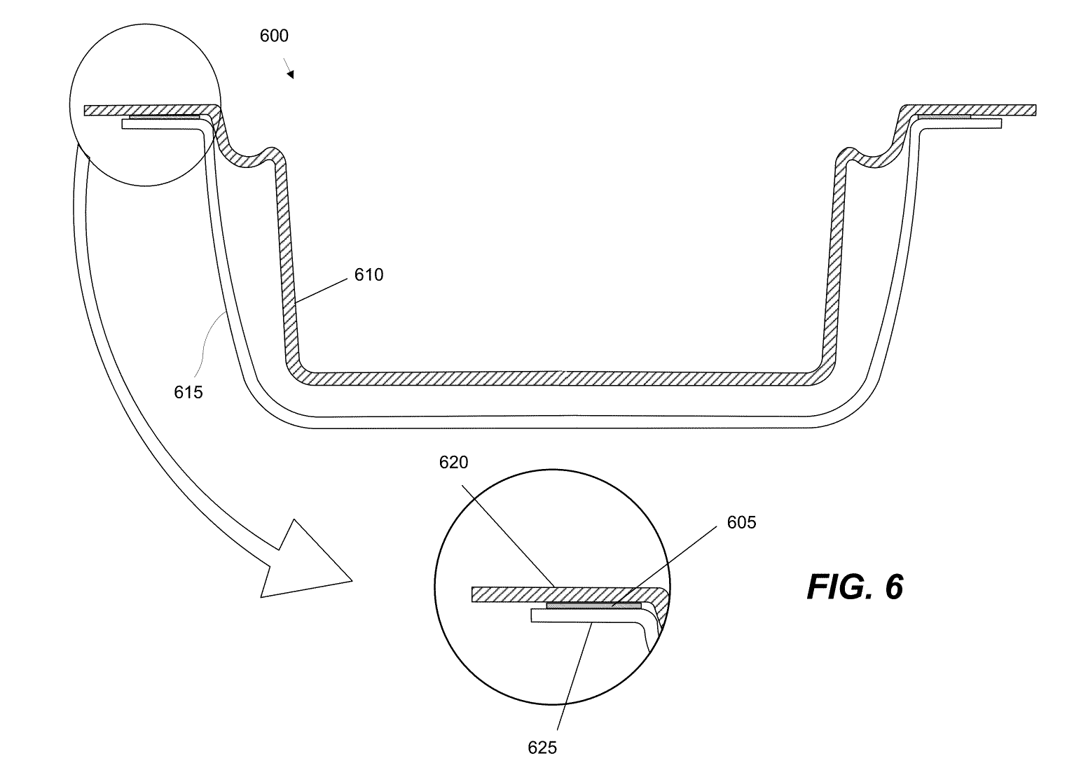

As mentioned above, in some embodiments, the edges of the outer and inner shells of the container are welded together, then rolled, and finally compressed to form a rolled joint. In some embodiments, a sealing member is placed within the rolled joint to hermetically seal the inner chamber. FIG. 6 illustrates a sealing member 605 that assists in sealing the inner chamber of a multi-layered cooking apparatus according to some embodiments of the invention. In some embodiment, the sealing member is ring shaped and placed around and between edges 620 and 625 of the inner and outer shells 610 and 615. That is, during manufacturing, the sealing member 605 is placed between the pressed edges 620 and 625 of the inner and outer shells 610 and 615. The sealing member 605 can be placed anywhere between the outer and inner portions of the edges 620 and 625 of the inner and outer shells 610 and 615.

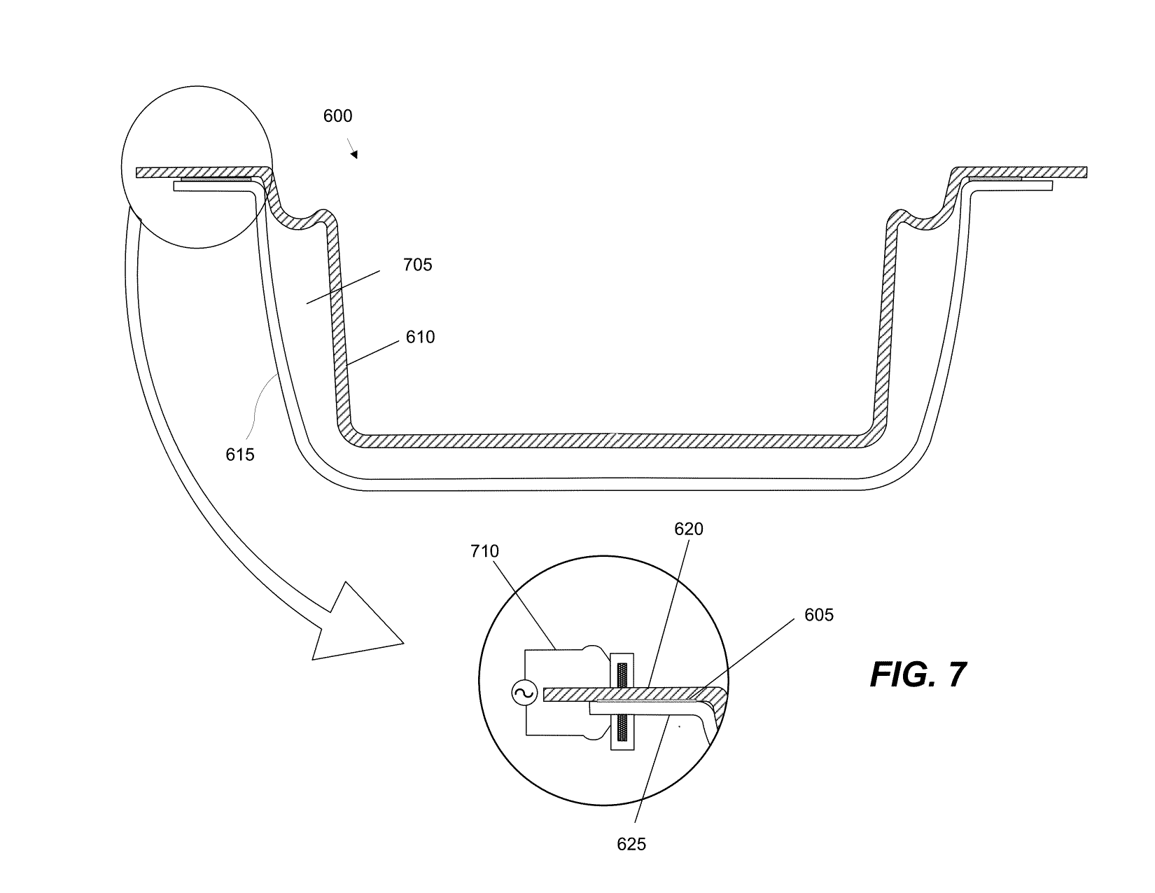

FIG. 7 illustrates an example welding process to weld the edges of the inner and outer shells together. To prevent the passage of fluid in and out of the inner space 705 and to prevent the buildup of pressure, the flanges 620 and 625 of the inner and outer shell 610 and 615 are electrically welded at a welding point. The edges 620 and 625 are placed between an upper electrode pole and a lower electrode pole of an electric welding machine 710. With the sealing member 605 placed between the pressed edges 620 and 625 of the inner and outer shells 610 and 615, the cooking vessel 600 is then rotated with respect to the upper and lower electrode poles of the welding machine 710, in some embodiments.

Alternatively, another way of seamlessly welding the top flange to the bottom flange is by first embossing a surrounding edge of the top flange to form a protrusion of a predetermined height and utilizing an electric pole and electric plate style welding machine. In some embodiments, the edges of the inner shell and the outer shell are welded together by a seamless welding method. Alternatively, the edges can be welded by an argon arc method. Further, the edges 620 and 625 can be welded together first by a seamless welding and then finished by an argon arc welding at the end.

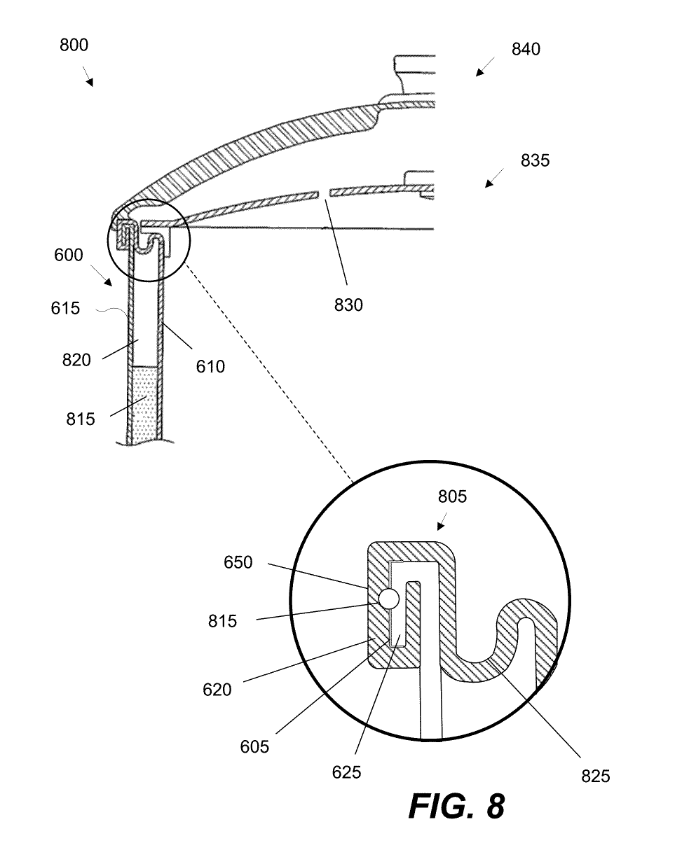

After sandwiching the sealing member 605 in between and around the edges, and welding the edges, the welded edges are then rolled to form a rolled joint (hereinafter referred to as an interlocking joint). FIG. 8 shows an interlocking joint 805 according to some embodiments. As will be described in detail below, the figure also shows how the cooking apparatus 800 of some embodiments is a waterless cookware that traps moisture.

In some embodiments, an interlocking joint 805 is formed by jointly curling the edges 620 and 625 of the two shells 610 and 615 together with the sealing member 605 placed in between and around the edges. As shown in FIG. 8, in some embodiments, the top edge 620 of the inner shell 610 is rolled at least 360 degrees about the same axis, and the bottom edge 625 of the bottom shell 615 is rolled about half as much as the top edge 620. The rolled edges are then substantially flattened along with the sealing member 605 to form the interlocking joint. The end result can be a hook-like shape with the two edges interlocked with one another, as illustrated in the figure.

The interlocking joint 805 with the sealing member 605 prevents the heat conduction medium 815 in the inner space 820 from escaping through the joint. Also, it 805 prevents water from seeping into the inner space; therefore, it substantially reduces the risk of explosion. This may be only true if the container is not equipped with a pressure relief valve. The apparatus 800 of some embodiments has a pressure relief value (not shown). So, an explosion or a separation of the two shells 610 and 615 due to high pressure within the inner space 820 is not likely to occur under normal use.

In some embodiments, the sealing member 605 sits between the outer edges of the two shells 610 and 615 to prevent water from even reaching the welding point 815. Alternatively, the sealing member 605 may sit on the inner edges of the two shells 610 and 615 past the welding point 815. In some embodiments, the sealing member 605 sits on both sides of the welding point, as illustrated in FIG. 8.

As mentioned above, the cookware of some embodiments has features that make it a waterless cookware. In some embodiments, the cookware has a grooved rim to trap moisture and use the trapped moisture as a seal. This seal prevent additional moisture from leaving the container through any opening between the groom rim and the cookware's lid.

Referring to FIG. 8, the inner rim 825 is shaped in a groove-like manner. When moisture evaporates through an opening 830 or a discharge port of the inner lid 835 of the apparatus, the groove of the inner rim 825 collects a pocket of moisture. The collected moisture acts as a moisture seal that prevents any additional moisture from leaving the apparatus. For instance, steam may come out of the steam hole(s) 830 of the inner lid 835 and hit the inner surface of the outer cover 810. Thereafter, the moisture may condense into water and flow down into the concave or grooved rim 825 of the inner shell 610. The moisture may flow down the dome-shaped inner lid or the dome-shaped inner surface of the outer lid into the grooved rim 825.

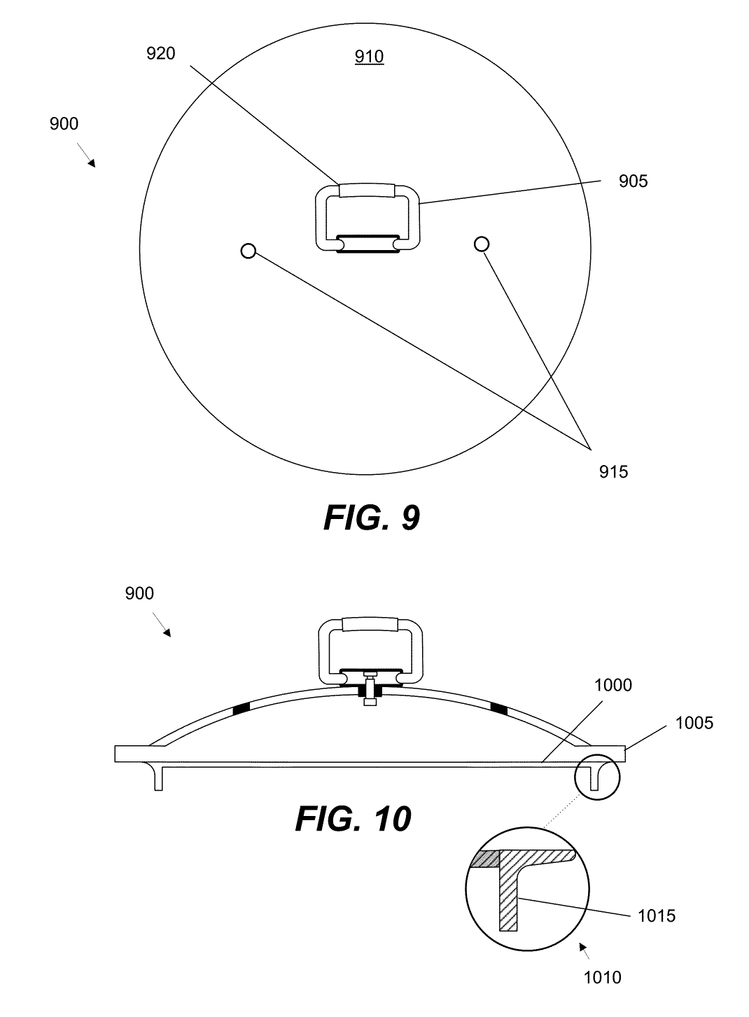

In some embodiments, the cooking apparatus includes an inner lid that works in conjunction with the grooved rim to prevent steam from leaking through the side or some space between the inner lid and the grooved rim where the inner lid sits. FIG. 9 illustrates a top view of an inner lid 900 according to some embodiments. In some embodiments, the lid 900 is made of glass, such as tempered glass. The glass lid allows a person to “look and cook”, meaning open the outer lid (not shown) and peek inside the container without removing it. The glass lid is one of the features of the cooking apparatus to save nutrients during cooking. This is because, during cooking, there can be nutrient loss each time the lid is removed from the container.

As illustrated in FIG. 9, the lid 900 has several steam holes 915. The lid 900 has a handle 905. In some embodiments, a hole is formed on the center of the lid 900, and a coupling member (e.g., a screw) is inserted in the hole to couple the lid to the handle 905. In some embodiments, the handle 905 is made using metal, such as stainless steel. In the illustrated example, the handle 905 is made safe to touch with a piece of silicone rubber 920. The silicone rubber 920 wraps around a central portion of the handle.

In some embodiments, a silicone ring is attached to the peripheral portion of an inner lid. The silicone ring prevents steam from leaking through some space between it and the grooved rim where the inner lid sits. FIG. 10 illustrates a silicone ring 1000 that is attached to the inner lid 900. The silicone ring 1000 is firmly attached in some manner (e.g., glued, screwed, fastened) to the inner lid 900. The ring 1000 may be attached to an outer metal ring 1005 that surrounds the glass portion of the lid.

The cross-sectional view 1010 of the silicone ring 1000 shows that it has a downward projecting form. The form appears similar to an upside down “L”. In some embodiments, the form of the silicone ring 1000 plays a role in sealing the container. For instance, with built up pressure, the downward projecting portion 1015 is pushed outwards to substantially seal the side area or any space between the silicone ring 1000 and the grooved rim (not shown) where the inner lid sits. Thus, the silicone ring 1000 prevents water from leaking out through an open space between the edges of lid 900 and the container. Any water that escapes through the holes 915 may condense and fall into the grooved rim to form a moisture seal.

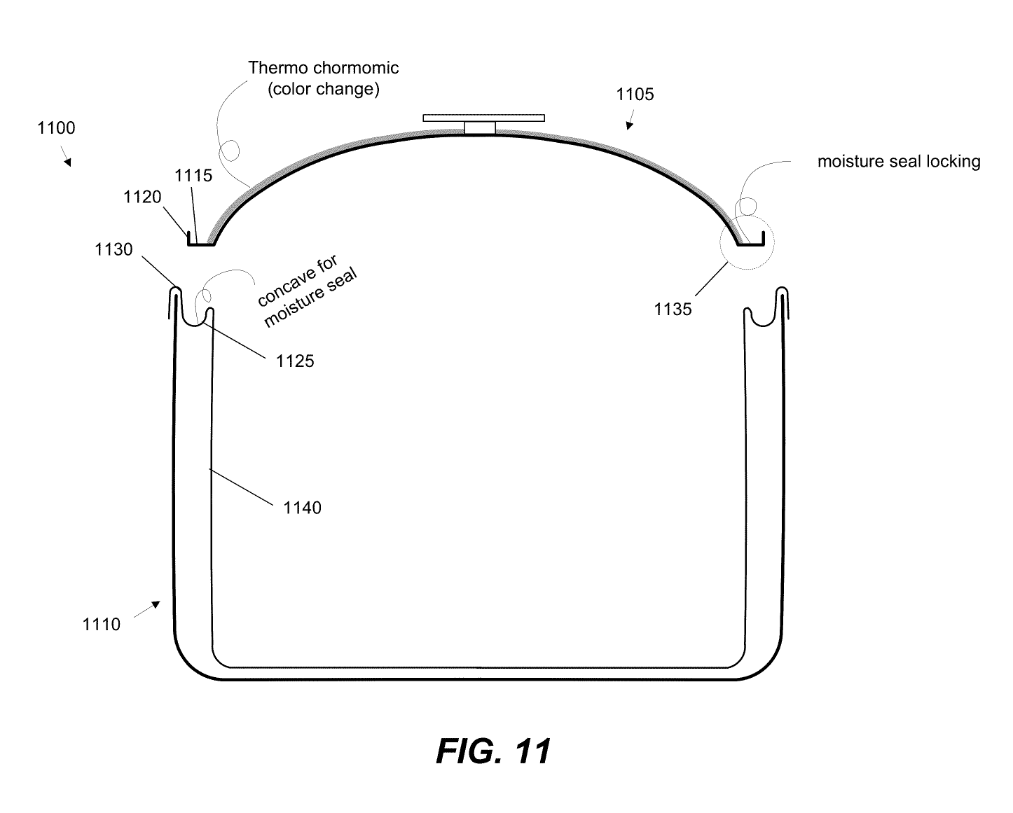

In some embodiments, the cooking apparatus has a cover that locks in or traps a moisture seal formed on a groove of the rim of the vessel. FIG. 11 illustrates a cooking apparatus 1100 with such a moisture seal locking cover 1105. As shown the moisture seal locking cover 1105 of some embodiments has an edge 1135 that is folded vertically (e.g., upwardly, downwardly) to facilitate in keeping the moisture in a grooved-rim 1125 of a vessel 1110. In the illustrated example, the lid 1105 has (i) an inner edge 1115 that is formed to sit flatly on the grooved rim, and (ii) an outer edge 1120 that is folded upwardly to fit snugly into the container around a vertical outer edge 1130 of the rim. The vertical outer edge 1130 is formed with the inner shell 1140, in some embodiments.

When the vessel 1110 is heated with a water-containing item and covered with the lid 1105, water eventually vaporizes and hits the lid's inner surface area (e.g., that is concaved). Some of that water may flow or trickle down into to the moisture groove 1125. The groove may then fill up with water to create a moisture seal. At the same time, the vertical form of the lid's outer edge 1120 and the matching vertical form of the container's outer edge 1130 create a locking mechanism that makes it difficult for the water to leak out through the side where the lid 1105 sits on the container 1110. This is because the vertical outer edge 1120 fits snugly around the vertical outer edge 1130 of the container 1110. Also, it is difficult for water to leak out of the side because it may have to travel up a tight space between the vertical outer edges 1120 and 1130 of the lid 1105 and the container 1110.

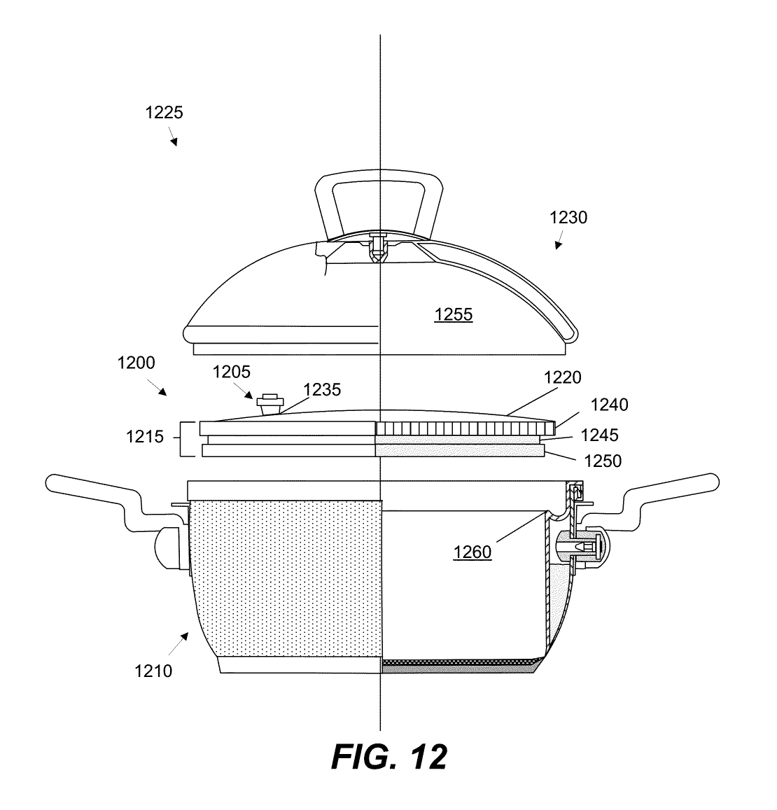

In some embodiments, the cooking apparatus comprises a lid that allows it to operate as a low pressure cooker. FIG. 12 illustrates a cross sectional view of a cooking apparatus 1225 with such a lid 1200. As shown, the cookware 1225 has a container 1210 having a multi-wall structure, including inner and outer shells, and the thermodynamic inner layer described above. The container of some embodiments has a grooved rim 1260 to create a moisture seal. In some embodiments, the apparatus has an outer lid 1230 that sits over the lid 1200.

In some embodiments, the low-pressure creating lid 1200 has a glass disk 1220 that is coupled in some manner to a rim 1215. For instance, in the example of FIG. 12, the rim 1215 has a top ring 1240 that is formed to surround and hold the glass disk 1220. In some embodiments, the glass disk 1220 is made of tempered glass. In some embodiments, the glass disk 1220 is dome-shaped or slightly curved, as illustrated in FIG. 12. In some embodiments, the rim 1215 is made of silicone rubber. In some embodiments, the rim 1215 is made of plastic, metal, and/or other suitable material.

As shown, the glass disk 1220 has an aperture or opening 1235 in which a pressure valve 1205 is installed. In some embodiments, the pressure valve 1205 is set to open up when it reaches predefined pounds per square inch (psi) value. That is, when the pressure within the container reaches the predefined limit, the valve opens up to let out excess pressure. In some embodiments, the pressure valve is set anywhere between 5 to 6 pounds per square inch (psi). As will be described below, the pressure valve 1205 of some embodiments includes a top cap, a valve made of elastic material, and a base. Instead of an elastic valve, the pressure valve is a spring-based valve, in some embodiments.

In some embodiments, the outer rim 1215 is formed to have a wide top ring 1240, a less wide bottom ring 1250, and a least wide middle ring 1245. In some embodiments, the bottom ring 1250 has a flat side or edge that fits firmly or snugly into the container. The middle ring 1245 has a flat side that facilitate in pushing the bottom ring 1250 into the container until the top ring 1240 sits on the grooved rim 1260 of the container 1210. In some embodiments, the bottom edge of the top ring 1240 sits on the grooved rim 1260. The top ring 1210 of some embodiment has a flat side that facilitates in locking in a moisture seal formed on the grooved rim 1260. An example of locking in a moisture seal is described above by reference to FIG. 11.

Having described several components of the apparatus 1225 of FIG. 19, the operations of the apparatus in cooking a food item under low pressure will now be described. When the container 1210 is heated with the food item, pressure starts building up within the container due to the heated water content of the food item. The pressure causes the outer rim 1200, which snugly or firmly fits into the container, to be pushed outwards. This prevents steam from leaving though the sides of the inner lid 1200. At the same time, the predetermined pressure level of the pressure release valve 1205 keeps the food item cooking under low pressure. However, when there is excess pressure, the pressure valve 1205 opens up to let out excess steam. The steam may collect in the upper area of the apparatus 1225 between the inner lid 1200 and the outer lid 1230. The steam in the upper area creates an upper thermodynamic upper layer 1255 that further insulates the container 1210. The moisture in the upper area 1255 may then condense into water and flow down into the grooved rim 1260 of the container 1210 to form a moisture seal, which further prevents moisture from leaving through the sides of the inner lid 1200 and allows the food item to cook or baste in its own juices.

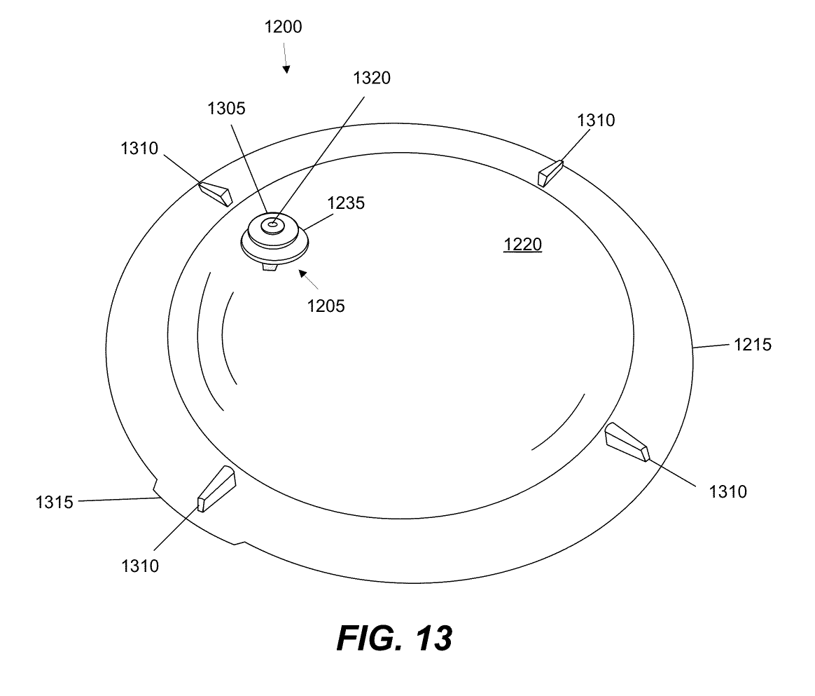

FIG. 13 shows a top perspective view of the low-pressure creating lid 1200 of FIG. 12. The lid 1200 has the glass disk 1220. The lid has the outer rim 1215 or safety ring that surrounds the glass disk 1220. The outer rim 1215 may be made of silicone rubber. The figure also shows a top cap 1305 of the pressure release valve 1205. In some embodiments, the cap 1305 is inserted into the opening 1235 to house an elastic valve or spring-based valve (not shown). The cap 1305 has an exhaust port 1320 or vent to allow steam to leave the container when the pressure within the container reaches a predetermined low pressure threshold limit.

In some embodiments, the outer rim 1215 includes a set of one or more handles. A handle can be placed on the disk 1220, but placing it may require another aperture on the disk. Thus, in the example of FIG. 13, the set of handles 1310 is formed on the rim 1315. In some embodiments, the set of handles 1310 are a set of top handles, and the lid has a set of one or more side handles. For instance, in the illustrated example, a portion of the outer round edge of the outer rim 1215 projects outwardly to form a side handle 1315.

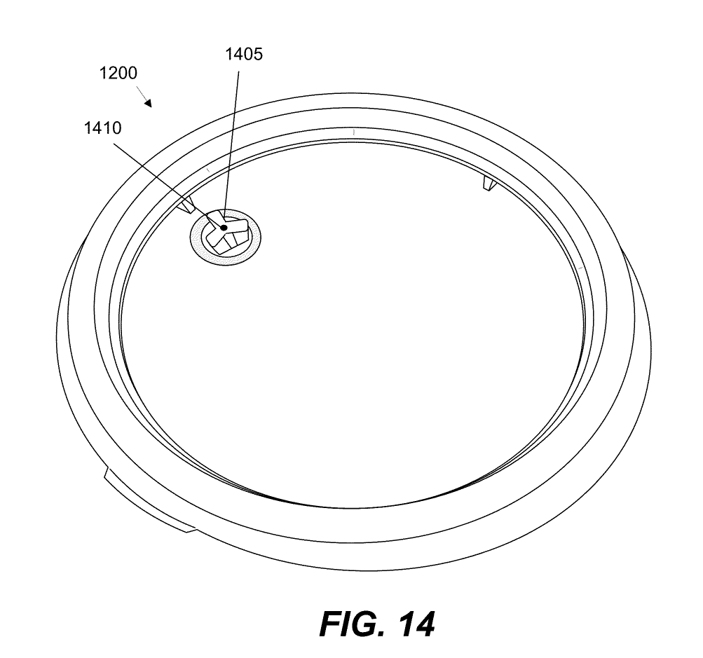

FIG. 14 shows a bottom perspective view of the low-pressure creating lid 1200 of FIG. 12. In particular, the figure shows that the pressure valve of some embodiments has a base 1405 that holds a valve in place. The base has an input port 1410 or opening where steam enters and adjusts the valve accordingly. To house the silicone valve, in some embodiments, the upper portion of the base 1405 is inserted into the top cap. In some embodiments, the base 1405 screws onto the upper cap.

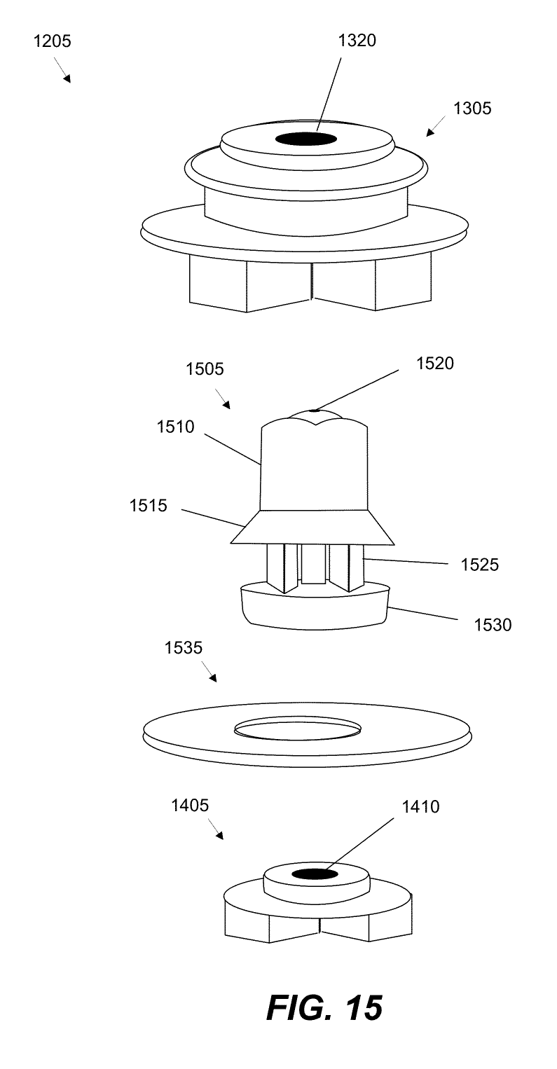

FIG. 15 shows an exploded view of a pressure release valve 1205 according to some embodiments of the invention. The pressure release valve 1205 has a top cap 1305 to house an elastic valve 1505. A base 1405 is used to hold the elastic valve in place within the cap 1305. In some embodiments where the base 1405 is screwed onto the cap 1305, a washer 1535 is placed between the lid and the base 1405. The washer 1535 prevents the base 1405 from slowly unscrewing itself from the cap 1305 (e.g., due to vibration).

As mentioned above, the cap 1305 has an exhaust port 1320 or vent to allow steam to leave the container when the pressure within the container reaches a predetermined low pressure threshold limit. The cap can be made of different materials in different embodiments. For instance, the cap can be made of metal, plastic, or silicone rubber. In some embodiments, the cap is formed to house an elastic valve or spring-based valve. For instance, in the example of FIG. 15, the cap has an elongated opening, and an elastic valve 1505 is inserted into the cap 1305 through that opening. The elastic valve 1505 creates a low pressure cooking environment by regulating pressure within the container.

In some embodiments, the base 1405 holds the elastic valve in place. The base 1405 has an input port 1410 or opening where steam enters and adjusts the elastic valve 1505 accordingly. To house the elastic valve, in some embodiments, the upper portion of the base 1405 is inserted into the top cap. In some embodiments, the base 1405 screws onto the cap 1305. Similar to the cap, the base 1405 can be made of different materials in different embodiments.

As shown, the elastic valve 1505 includes a head 1510 with a hole 1520. The valve also include a base 1530 to push and expand the head such that the hole 1520 opens up to output steam. In some embodiment, the base has several pillars 1525 formed thereon to push the head 1510. For instance, in the example of FIG. 15, the base includes three pillars 1525 that push the head evenly from three different positions.

In some embodiments, the elastic valve 1505 is made of silicone rubber. The head, body, and base can be one single piece silicone rubber. In some embodiments, the head 1510 is formed using an elastic material, such as silicone rubber, and the body and base are formed together using the same elastic material or a different material, such as plastic.

In some embodiments, the cooking apparatus has an exothermic plate attached to its bottom side to absorb thermal energy. The exothermic plate may be a ceramic plate with exothermic particles (e.g., ferrite, aluminum oxide) to absorb and generate thermal energy. The exothermic plate may be a clay plate with the exothermic particles.

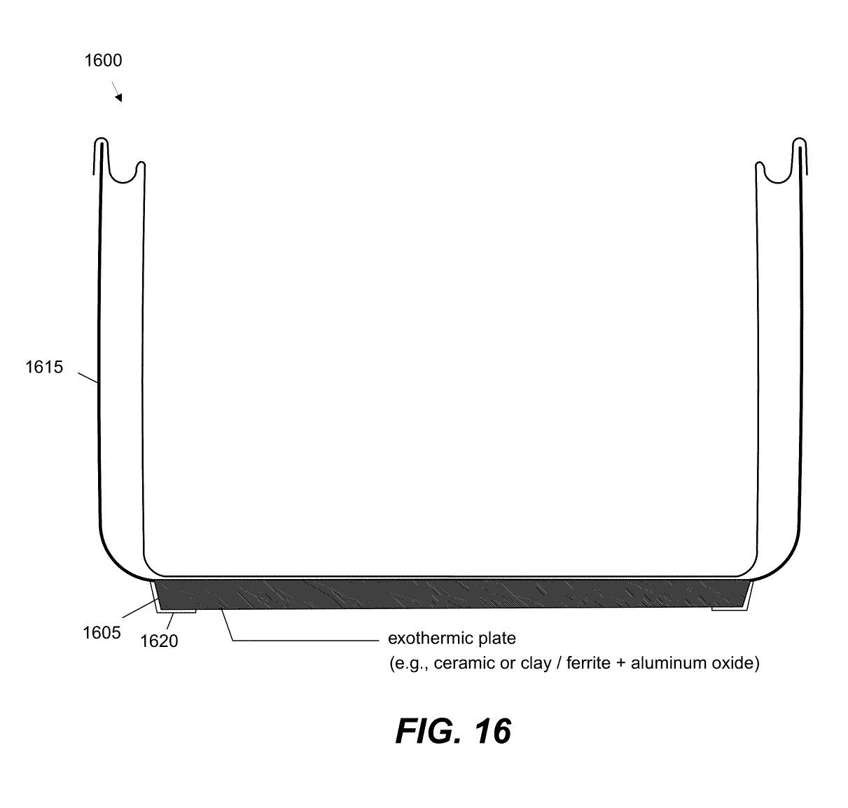

FIG. 16 illustrates a multi-layered container 1600 with such an exothermic plate 1605. As shown, the exothermic plate 1605 is attached to the bottom surface of the outer shell 1615. This is so that the cookware becomes a multi-purpose cookware that can operate with different types of kitchen appliances, including a microwave oven, a gas stove, an electric stove, and an induction cooker.

In some embodiments, the exothermic plate 1605 allows the container 1600 to be used with a microwave oven. The exothermic plate 1605 coverts microwave radiation to thermal energy. In some embodiments, the exothermic plate 1605 is composed of a far-infrared emitting heating material. In some embodiments, the exothermic plate includes at least one of ferrite (α-Fe) and aluminum oxide (Al2O3). In some embodiments, the exothermic plate is formed by mixing ferrite and aluminum oxide compounds into clay or ceramic.

In some embodiments, the plate 1605 has clay ceramic powder mixed with iron oxide powder (Fe2O3) powder and magnesium-Zinc (Mn—Zn) silicate powder. In some embodiments, the plate is made with clay ceramic powder mixed with iron (III) oxide powder (Fe2O3) powder and copper-nickel-zinc (Cu—Ni—Zn) powder for electro-microwave absorption. In some embodiments, the clay ceramic includes at least one of manganese zinc (MnZn) powder, magnesium copper zinc (MgCuZn) powder, and nickel zinc (NiZn) powder. Instead of Fe2O3, some embodiments use Fe3O4 (iron (II,III) oxide) powder. In some embodiments, the plate is made of ferrite silicone mixture and Fe3O4 powder.

In addition to a microwave oven, the exothermic plate 1605 can be heated using a gas or electric stove. This is because the exothermic plate 1605 can withstand up to or in excess of 1205° C. By contrast, a stovetop only reaches up to around 500° C.

In some embodiments, the exothermic plate 1605 is attached to the container 1600 with a plate cover 1620. As the exothermic plate 1605 may not operate efficiently on an induction cooker, the plate cover 1620 may be magnetic. The magnetic properties of the plate cover 1620 allow the cooking apparatus to operate with an induction cooker.

As mentioned above, the cooking apparatus of some embodiments provides a flow path that allows a thermal conductive medium to flow across and around the bottom of the inner chamber. FIG. 17 shows a heat transfer plate 1700 that has such a flow path 1715. In some embodiments, the heat transfer plate 1700 is affixed or attached in some manner (e.g., bonded) between the bottom portions of the outer and inner shells.

As shown in FIG. 17, the flow path 1715 is formed on the heat transfer plate 1700. The flow path includes a circular recess 1720 at the center area of the heat transfer plate 1700. The heat transfer plate 1700 includes several grooves 1725 that extend from the circular recess 1725 to edges of the circumference in all directions. The grooves 1725 can extend in parallel with each other from portions of the circumferential edge to the corresponding portions of the circumferential edge, respectively.

In some embodiments, the grooves 1725 extend from portions of a circumferential edge to the corresponding portions of the circumferential edge so as to cross with each other. The heat transfer plate 1700 can have any number of grooves. For instance, there can be two grooves on opposite sides of one another. The grooves can be placed on four opposite sides, six etc. In the example of FIG. 17, eight grooves 1725 extend radially from the circular recess 1720 on the heat transfer plate 1700.

In some embodiments, the circular recess 1720 is a concentric recess. The concentric recess is formed between a center and an edge of the heat transfer plate so as to have a predetermined width. In some embodiments, at least two straight grooves 1725 extend from the concentric recess to the edge.

Further, as shown in FIG. 17, the heat transfer plate 1700 can be a disc, in which a circular island 1730 is formed at a center of the disc and several islands 1735 are formed at a circumference. Hence, a concentric recess having a predetermined width is formed between the circular island 1730 at the center and the several islands 1735 at the circumference. And, several straight grooves 1725 extend to the edge from the concentric recess.

In some embodiments, the concentric recess 1720 is formed to have the width W about a half of a radius R of the disc, and eight straight grooves 1725 extend from the concentric recess to the edge.

In some embodiments, the sizes of the islands 1735 can be modified so as to form several small pillar type islands. Density of the pillars formed on a unit area is adjusted in a manner that the density on the portion contacted directly with the flame of the burner is decreased while the density of the center and circumference is increased. In some embodiments, the density of the pillars at a central or circumferential portion of the heat transfer plate is greater than that of the rest pillars.

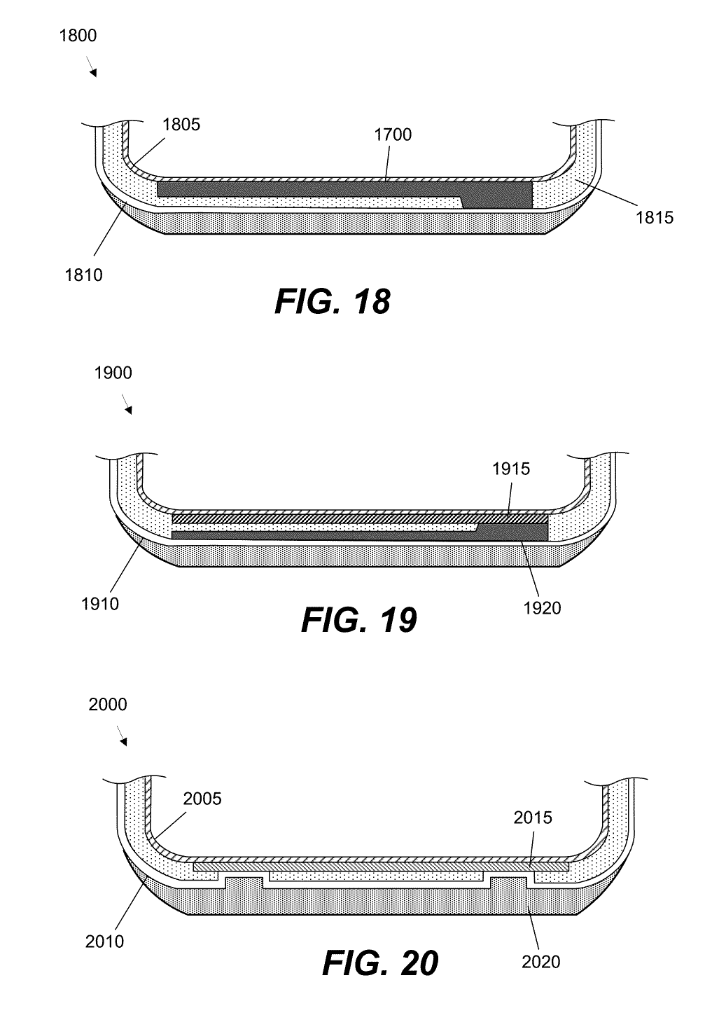

As mentioned above, the cooking apparatus of some embodiments provides a flow path that allows a thermal conductive medium to flow across and around along its bottom area. FIG. 18 illustrates a cross-sectional view of a multi-layered vessel 1800 in which the heat transfer plate 1700 is bonded to inner and outer shells 1805 and 1810 so as to construct a stacked structure of bottom plates. As illustrated, the 1815 medium can move in all directions along the grooves as a fluid pathway is formed on the heat transfer plate 1700. In some embodiments, a surface of the heat transfer plate failing to have the grooves can be attached to the inner shell.

The surface that does not have the grooves can be attached to the outer shell.

FIG. 19 illustrates a cross-sectional view of a multi-layered vessel 1900 in which (i) a flat heat transfer plate 1915 is attached to a lower part of an inner shell, and (ii) another heat transfer plate 1920 having a flow path of a heat medium fluid is attached between the flat heat transfer plate and an outer shell 1910 so as to construct a stacked structure.

FIG. 20 illustrates a cross-sectional view of a multi-layered vessel 2000 in which a flow path is formed with at least one of the vessel's shell. In the illustrated example, the flow path of the heat medium is formed on the outer shell 2005. In some embodiments, an outer heat transfer plate 2020 is installed at a lower part of the outer shell, and the outer heat transfer plate 2020 has at least one groove having the same shape of the outer shell. In some embodiments, a piece of metal 2015 (e.g., a stainless steel plate) is added between the inner and outer shells 2005 and 2010.

As mentioned above, the cooking apparatus of some embodiments has a pressure release valve to relive pressure within the inner chamber between the inner and outer shell. FIG. 21 shows a cross-section view of a pressure release valve of some embodiments. As shown, the pressure release device 2100 is in contact with the vessel through a clamping hole. The pressure device has a spring housing 2106 that is affixed to the outer shell 2101 of the vessel. The spring housing 2106 holds a spring 2120 that contracts with exerted pressure from the inner chamber of the vessel. The pressure release device 2100 also includes a valve head 2108 that seals the inner chamber. The valve head 2105 is pushed back in accordance with the tension of the spring 2120 to relieve any pressure built up within the inner chamber of the vessel. The valve head maybe made of silicone rubber, plastic, or metal.

According to some embodiments of the present invention, the spring housing 2106c has a shape of a screw or bolt, which is securely affixed to the outer shell 2101 using a fastening nut 2110. The spring housing 2106 defines an opening 2106a with an elongated spring device hole at one end and a pressure controlling hole 2106b at opposite end, thus sharing the same center axis. On the outer circumference of the spring housing 2106 that defines the spring hole 2110a, there are threads for receiving (e.g., screwing on) the fastening nut 2110. The fastening nut 2110 has an opening 2110a to discharge excess pressure built-up within the inner chamber between the inner and outer shells.

At the other end of the spring housing 2106, a screw head 2106d is formed to abut against the inner surface of the outer shell. In some embodiments, a washer or packing 2112 may be provided between the screw head 2106d and the outer shell to secure the sealing thereof.

Instead of a spring-based valve, the cooking vessel of some embodiments uses a valve made of elastic or compressible material. FIG. 22 shows a pressure control valve 2200 according to some embodiments of the invention. As shown, the valve 2200, in some embodiments, is made of an elastic or compressible material. The valve 2200 includes a head 2205 having a conical figure so as to open/close an opening formed on the outer shell of the vessel. The valve also includes a support frame 2215 that extends from the head 2205. The shape of the head 2205 may be of a spherical shape and the like. The diameter of the head 2205 is large enough to effectively seal the opening formed on the outer shell of the cooking vessel.

In some embodiments, a recess 2220 is formed on the head 2205 (e.g., on the side nearest to the opening formed on the outer shell) so as to receive a large force (pressure) generated from concentrating the pressure within the inner chamber of the vessel (e.g., on to the smaller square area of the recess instead of the whole side of the head 2205 nearest to the opening).

In some embodiments, the head 2205 extends from a support frame 2215, which has a hollow cylindrical figure, by a neck 2210, which is securely attached or formed next to the head and the support frame. In the example of FIG. 22, the diameter of the neck 2210 is smaller than the diameter of the support frame 2215, thus facilitating the compressibility of the valve 2200. Also, this difference in diameter facilitates further discharge of excess pressure through the support frame 2215 as well. At low temperatures or when there is insufficient pressure (e.g., steam pressure) generated within the inner chamber, the head 2205 effectively seals the opening formed on the outer shell to prevent unnecessary heat loss.

In some embodiments, the valve 2200 is made with silicone rubber because of its elasticity as well as its resistance to high temperature. In some embodiments, a minimum pressure (e.g., between 0.5 and 0.6 Kgf/cm²) is set to cause movement of the head 2205 of the valve 2200 away from the opening formed on the outer shell.

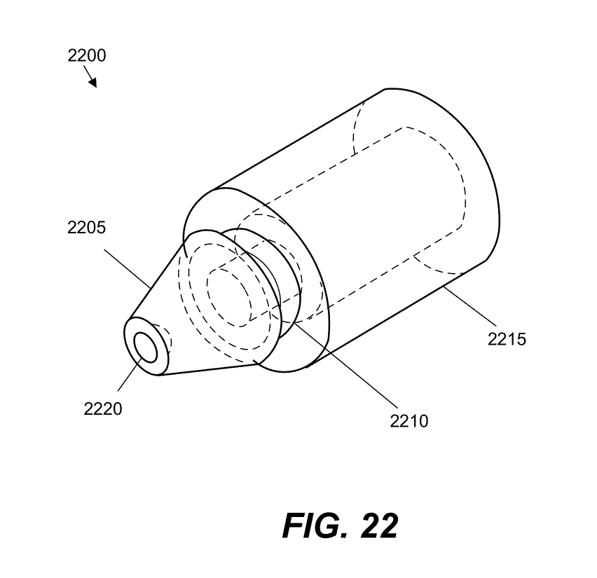

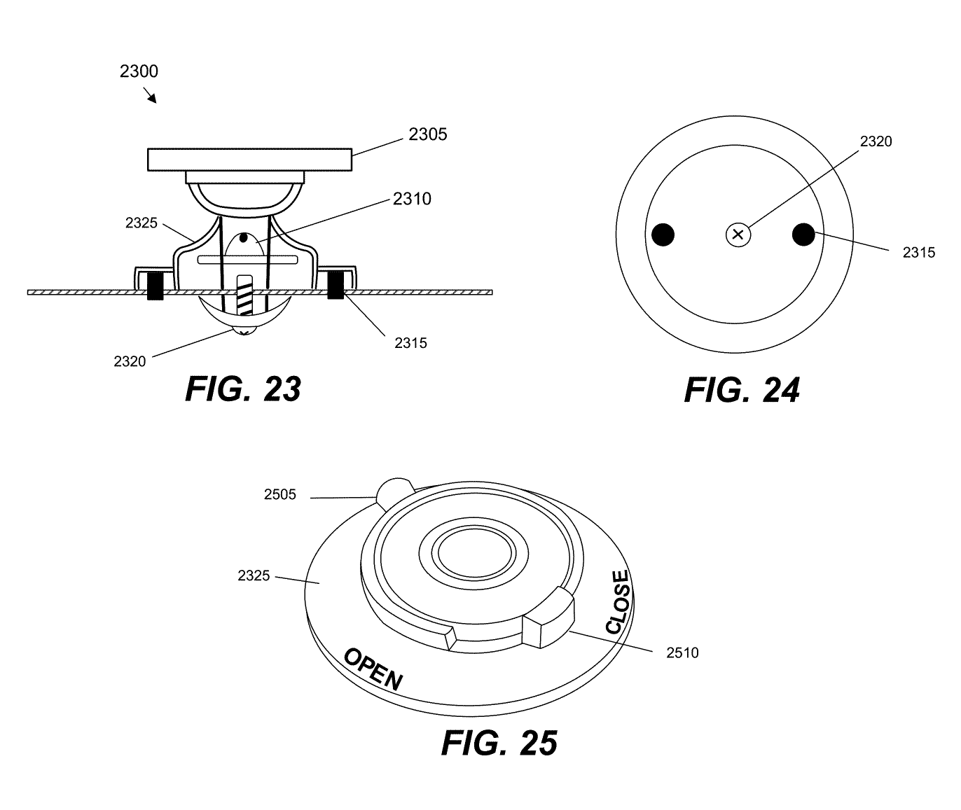

In some embodiments, the lid includes a handle. The handle can be used to place the lid on top the vessel or remove it from the vessel. FIG. 23 shows a cross sectional view of a lid handle 2500 according to some embodiments of the invention. The handle includes a top handle portion 2305, and a body or bottom portion 2325. In some embodiments, the body 2325 is screwed onto the lid with a screw 2320. The handle 2300 may also include one or more support members 2315 to prevent the handle from rotating on or disengaging from the lid. In some embodiments, the lid includes a whistling component or member 2310 that whistles when the vessel exerts vapor. In the example of whistling member 2310 is a part that is housed in the body of handle. The whistling member may be made of metal (e.g., stainless steel) or some other material (e.g., plastic).

FIG. 24 shows a bottom view of the handle 2300 according to some embodiments. This figure shows that that the handle of some embodiments is attached to the lid with a screw 2320. The handle can also include one or more support members 2315 to keep the handle in place in a particular position so that the handle remains in place and is not rotated.

In some embodiments, the lid includes a pressure release switch. FIG. 25 shows a lid handle 2300 with such a pressure release switch 2510. The switch 2510 sits on top of the body 2325 of the handle. In some embodiments, the switch has a round shape that allows it to be rotated or switched to different positions such as open and closed positions. The switch is inserted into a hole formed on the bottom portion 2325 of the handle. On the side of the bottom portion of the handle is a hole 2505 or an exhaust port. When the switch is in the open position, the hole allows steam to exit the vessel.

As shown, the switch can be rotated in one direction to release steam or heated vapor through one or more holes of the lid. The switch can also be rotated in the opposite direction to substantially seal the microwaveable vessel. The vapor, however, may still leave the vessel through the hole formed on the whistling member 2310.

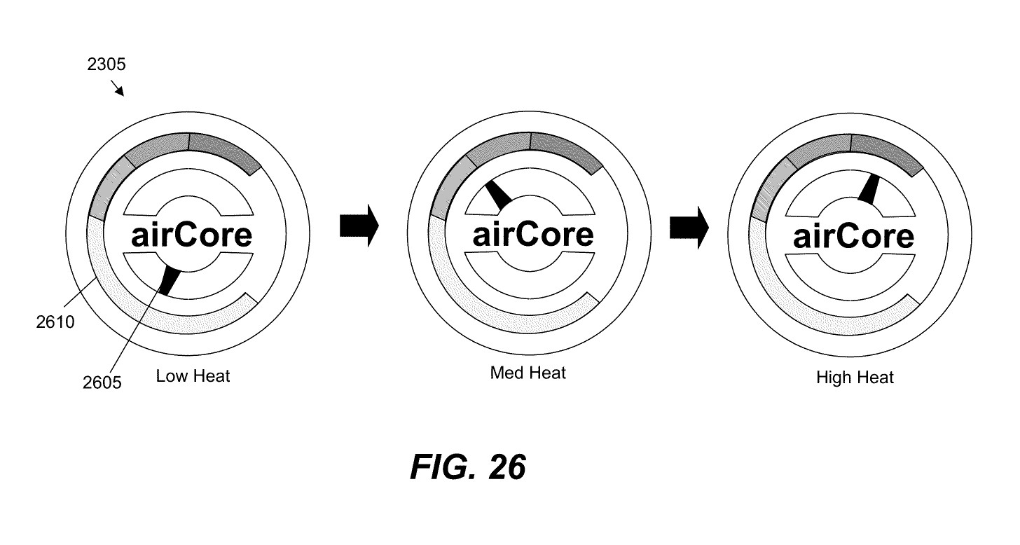

FIG. 26 shows the top view of the lid handle according to some embodiments. As shown, the lid handle includes a temperature gauge 2610 (e.g., on the top portion 2305 of the handle). The gauge 2610 includes a knob 2605 that rotates with the change in temperature within the vessel. In some embodiments, the gauge is marked in some manner to provide a visual indication of the temperature within the vessel. In the example of FIG. 26, the knob rotates to different colors as the temperature changes. For instance, the gauge 2610 may provide different colors to represent low heat, medium heat, high heat, etc. Instead of or in conduction with color indicators, the gauge 2010 might provide textual indicators, numerical indicators, and/or other visual indicators.

In some embodiments, the apparatus includes one or more handles that can be clicked and locked into one or more different positions. In some embodiments, the apparatus has two such handles on opposite sides of the container. FIG. 27 illustrates an example of a click and lock handle 2700 according to some embodiments of the invention. Specifically, this figure shows two views 2700 and 2705 of the click and lock handle 2700. The first view 2705 shows the handle 2700 in a downright position, while the second view 2710 shows the handle in a side lateral position. The downright position represents a position to store the container, while the side lateral position represents a position to safely handle the container.

The click and lock handle 2700 can be placed on any different types of containers. For instance, a pair of click and lock handles may be attached to a single walled cooking container. The pair of handles may be attached to a doubled walled cooking container. The click and lock handle is particularly useful for a doubled walled container. This is because the double walled vessel that is capable of containing a certain amount of food item takes up more space than a single walled container that is capable of containing the same amount of food item.

As shown in FIG. 27, the click and lock handle 2700 has a handle 2715 and a locking member 2725. In some embodiments, the handle 2715 is made of metal, such as stainless steel. However, different embodiments can use different materials. The handle 2715 has an open area. The open area allows the connector to cover a portion of the handle 2715. This is so that the handle rotates along an axis on the side of the vessel 2730. The handle 2715 also has several guiding members 2720, which may be formed on the handle itself.

FIG. 27 shows that, in some embodiments, the locking member 2725 is also a handle connector. The handle connector 2725 rotatably couples the handle 2715 to the vessel 2730. In some embodiments, the handle connector 2725 is made of metal, such as stainless steel. However, different embodiments can use different materials. The connector 2725 includes several grooves or open regions 2720 to guide the guiding members 2720 along the same axis. In some embodiments, the grooves are formed on a raised portion of the connector. The raised portion is then placed over the side of the handle 2715 where the matching guiding members 2720 are formed.

In some embodiments, each open region guides the handle from one of two different positions: a downright position and a lateral position. The groove starts from the bottom of the connector and end at about the side lateral position to lock the handle in that position.

In some embodiments, each guiding member 2720 of the handle 2715 extends laterally a predefined length to lock the handle in the side lateral position. The handle cannot rotate beyond the lateral position. This means that, in some embodiments, the handle cannot be rotated upright to an upright position or even a slightly upright position. This is a safety mechanism to allow a person to safely carry the vessel 2730 without the handle 2715 suddenly rotating upright.

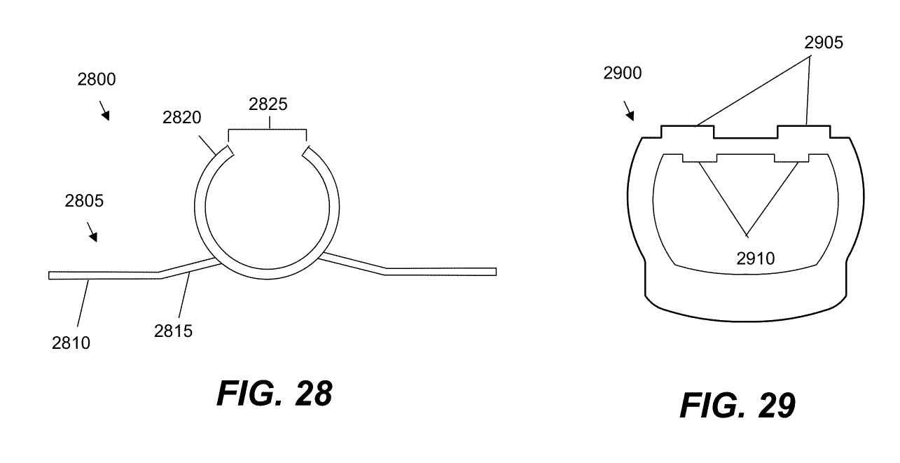

In some embodiments, the click and lock handle 3505 has a clicking member to click the handle in one of the two different positions. In some embodiments, the clicking member includes a spring. FIG. 28 illustrates a spring 2800 of the click and lock handle of some embodiments. The spring 2800 has a spring base 2805, including (i) outer sections 2810 that are substantially flat and (ii) inner sections 2815 that are angled to support an elongated ring 2820. The elongated ring 2820 has an open section 2825 to click the handle in and out of the lateral position.

FIG. 29 illustrates a handle 2900 of the click and lock handle according to some embodiments of the invention. As shown, the handle 2900 has several handle connector guides 2910. In some embodiments, the handle 2900 includes several spring guiding members 2905 that rotate along the elongated ring (e.g., to or from the open region). In some embodiments, the elongated side of the ring fits in between two spring guiding members 2905. When adjusting the handle position, the guiding members 2905 and the elongated side prevent the handle from moving side to side.

In some embodiments, the click and lock handle includes a support frame to support the spring. The support frame adds additional force to the spring so that the handle is not easily pushed out of position. For instance, the support frame may prevent the handle from clicking out of the lateral position without much force and rotating to a different position.

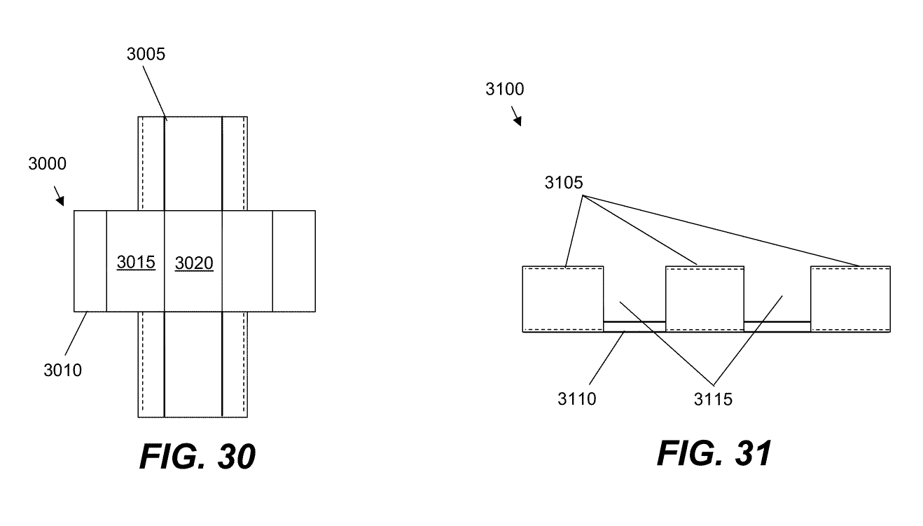

FIG. 30 illustrates a support frame 3000 of the click and lock handle according to some embodiments of the invention. In some embodiments, the support frame 3000 is shaped similar to the spring. Here, the support frame 3000 is rectangular. In some embodiments, the spring sits across the support frame with the elongated ring spanning perpendicularly across the middle of the support frame.

In some embodiments, the support frame 3000 has matching sections for the spring. For instance, in FIG. 30, the support frame 3000 has outer sections 3010 that are substantially flat, inner sections 3015 that are angled, and raised middle section 3020 to support the elongated ring. In some embodiments, the click and lock handle has a base frame 3005, and the support frame 3800 is attached to the base frame. In some embodiments, the base frame 3005 is coupled in some manner to the side of the container.

As mentioned above, the click and lock handle of some embodiments includes a handle connector. FIG. 31 illustrates a handle connector 3100 of the click and lock handle according to some embodiments of the invention. As shown, the connector 3100 includes a connector base 3110 to couple the handle to the vessel. The connector 3100 also includes a raised portion 3105. Several grooves 3115 are formed on the raised portion 3105 of the connector. In some embodiments, each groove cuts across about from about bottom of the raised portion to half way to the top of the raised portion in order to lock the handle in the side lateral position. As indicated above, this is part of a safety mechanism to allow a person to safely handle the vessel without the handle suddenly rotating and causing an accident.

While the invention has been described with reference to numerous specific details, it is to be understood that the invention can be embodied in other specific forms without departing from the spirit of the invention. Thus, it is to be understood that the invention is not to be limited by the foregoing illustrative details, but rather is to be defined by the appended claims.

What is claimed is:

1. A cooking apparatus comprising:
a container having a dual wall structure, including inner and outer shells,
wherein the inner shell is disposed adjacent the outer shell and edges of the shells are sealed to form a cavity between the shells,
wherein the cavity includes a thermal conductive medium to form a thermodynamic layer when the container is heated, and
wherein, to maintain a vacuum environment, the cavity includes a reactive medium to absorb gas molecules that are formed within the cavity when the container is heated; and
a cover to cover the container.

2. The cooking apparatus of claim 1, wherein the reactive medium is getter that includes zirconium (Zr).

3. The cooking apparatus of claim 1, wherein the thermal conductive medium is ambient air.

4. The cooking apparatus of claim 1, wherein the thermal conductive medium is silicone oil.

5. The cooking apparatus of claim 1, wherein, to seal the cavity, the edges of the outer and inner shells are welded together, then rolled, and finally compressed to form a rolled joint.

6. The cooking apparatus of claim 5, wherein a silicone ring is placed within the rolled joint to further seal the cavity.

7. The cooking apparatus of claim 1 further comprising a pressure release valve that is installed on a side of the container to release any excess pressure built up within the cavity when the container is heated.

8. The cooking apparatus of claim 1 further comprising a heat transfer plate placed along the bottom of the container between the inner and outer shells.

9. The cooking apparatus of claim 8, wherein the heat transfer plate has a flow path for the thermal conductive medium.

10. The cooking apparatus of claim 1, wherein the thermal conductive medium is a first thermal conductive medium, wherein the cover has a dual-wall structure, including inner and outer walls, and an inner space formed between the walls, wherein the inner space comprises a second thermal conductive medium.

11. The cooking apparatus of claim 10, wherein the first and second thermal conductive mediums are the same.

12. The cooking apparatus of claim 1, wherein the lid comprises a elastic ring with a downward projecting to substantially seal any open space between the lid and the container.

13. The cooking apparatus of claim 1, wherein the thermal conductive medium is a piece of fibrous or microporous material.

14. A cooking apparatus comprising:
a container having a dual wall structure, including inner and outer shells,
wherein the inner shell is disposed adjacent the outer shell and edges of the shells are sealed to form a cavity between the shells,
wherein the cavity includes a fibrous or microporous material to insulate the vessel; and
a cover to cover the container.

15. The cooking apparatus of claim 14, wherein the fibrous material is a piece of ceramic wool.

16. The cooking apparatus of claim 14, wherein the fibrous material is a quilted panel made using glass cloth.

17. The cooking apparatus of claim 14, wherein the microporous material is a microporous board made with pyrogenic silica.

18. The cooking apparatus of claim 14, wherein, to maintain a vacuum environment, the cavity includes a reactive medium to absorb gas molecules that are formed within the cavity when the container is heated.
